(19) United States
(12) Patent Application Publication
(10) Pub. No.: US 2004/0077198 A1
(43) Pub. Date: Apr. 22, 2004

(54) PC board ejector lever

(76) Inventor: Richard E. Schlack, Rising Sun, MD (US)

Correspondence Address: John J. Simkanich, Paul & Paul, 2900 Two Thousand Market Street, Philadelphia, PA, 19103, US

(21) Appl. No.: 10/674,482

(22) Filed: Sep. 30, 2003

Related U.S. Application Data
(60) Provisional application No. 60/414,871, filed on Sep. 30, 2002.
(60) Provisional application No. 60/437,601, filed on Dec. 31, 2002.
(60) Provisional application No. 60/462,347, filed on Apr. 11, 2003.

(51) Int. Cl. H01R 13/62

(52) U.S. Cl. 439/160

(57) ABSTRACT

An inject-eject lever latch mountable to the outside edge of a PC board to rotate relative thereto for assistance with board insertion and board pull-out, and for engaging and disengaging with a chassis mounted keeper, includes a projecting pawl which engages different faces of a cavity-type keeper during phases of its operation. The lever has a spring-biased lockout which when engaged holds the lever in a locked-down position against the board with the pawl fully engaged with the keeper upward wall thereby fully locking the board into position on a chassis. A manually operated release disengages the lockout function and causes the lever to automatically rotate partially outwardly from the board, which action also causes the pawl to move toward the keeper bottom wall. In a first aspect of the invention, a catch which includes at least one projecting foot to act as the pawl is carried on the lever for transverse movement relative thereto. The catch release is affected by manually pushing against the catch which acts as a button release. In a second aspect of the invention, the catch is mounted to the lever for sliding movement thereto. The catch release is affected by manually sliding the keeper and its projecting footed pawl out of position from the keeper in a direction along the lever. In a third aspect of the invention a catch is mounted to the lever which lever utilizes its front end as the pawl. A cantilevered flexible tab on the catch includes an operator button where the free end of the tab interferes with an adjacent facing edge on the lever creating an interference pinch point. Manually depressing the button releases the pinch point and the lever is free to rotate. In each aspect of the invention spring biasing causes the lever to initially rotate away from the PC board edge.

### RELATED APPLICATIONS

This application is related to, and claims priority of: U.S. provisional application No. 60/414,871, filed Sep. 30, 2002, for PC BOARD MOUNTED EJECTOR LEVER; and U.S. provisional application No. 60/437,601, filed Dec. 31, 2002, for PC BOARD SLIDING EJECTOR LATCH; and U.S. provisional application No. 60/462,347, filed Apr. 11, 2003, for SPLIT EJECTOR LEVER.

### BACKGROUND OF THE INVENTION

The present invention relates to latches and levers, specifically ejector latches and ejector levers which may be adapted for use to secure and release objects in tight quarters, such as printed circuit boards (PC boards) and the like held in cabinets or on electrics card racks.

Electronic modules held in larger enclosures may take the form of PC boards or PC cards mounted to slide in a rack, a tray, or along a rail, or which can be pressed into a connector slot. It has become increasingly important to be able to easily insert such a module with a positive “click-type” (or snap-in type) connection, and with a positive “pop-out-type” release. Moreover, it has become increasingly important to have an insertion aid and/or a pullout aid such as a handle or a hold.

A combination inject-eject latch would be suitable for such uses. These devices have been introduced into the art for other applications. For example, a pawl inject/eject latch is the subject matter of U.S. provisional application serial No. 60/295,179, filed Jun. 6, 2001 and titled: Pawl Inject/Eject Latch. This application discloses a latch device which is mounted to the face of a panel or drawer, and which is capable of injecting a module mounted onto the drawer and ejecting a module by ejecting the drawer face from the housing in which it is mounte. This device also acts to retain the module within an enclosure to maintain the electrical connection thereof even when jarred or jostled. This inject/eject latch includes a handle which can provide a grasping surface to assist in injecting, and a pivoting handle attached to a pawl, which when operated engages a fixed keeper to perform an inject and retention functions. A release button and spring biasing effects ejection that releases the pawl form the keeper and rotate the handle outwardly for manually grasping. Grasping the handle facilitates the removal of the module.

A spring biased pop-out handle is the subject matter of U.S. provisional application serial No. 60/371,527, filed Apr. 9, 2002, titled: Sliding Panel Latch. This latch does not eject the panel, but is biased to pop the handle open when a release mechanism is manually depressed and released.

A further button operated, spring biased, pop-put latch is the subject matter of pending U.S. patent application Ser. No. 10/159,890, filed Jun. 1, 2002, and titled: Latch With Bail-type mounting. This latch has the flat panel mounting configuration as that first described above.

PC cards (and PC boards) generally have narrower rack footprint than PC modules, as PC modules are generally larger and heavier boards, which often carry a reasonably wide rail at a first outer edge and a reasonably large connector at the second opposite edge. Such outer edge rails often include inward projecting guide pins to assist the proper alignment of the PC module connector. Manufacturers like Rittal International (Germany), Hoffman-Schroff electronic packaging division (Singapore) of Pentair, Inc. (USA), and Elma Electronic, Inc. (USA) electronic packaging subsidiary of Elma Electronic AG (Switzerland) have provided PCI (peripheral component interconnect) equipment for the computer and electronics industry. These manufacturers each supply module inject-eject CPCI (computer peripheral connection interconnect) cabinet, rack, or housing latches. Representative of these is the Rittal International part no. 3686135 product. These ejectors each require an outer edge rail or its equivalent to provide a needed mounting surface for the latch. This rail, which is mounted to the PC board, acts as a faceplate, mounting surface, much as with the panel or drawer need to mount the latch described above. The Rittal International latch engages a portion of a housing rack structure to inject and eject the connection of the PC module connector.

These PCI latches also each require a separate positive lockout structure to provide a lockdown function. Often used is a separate plate such as a hold down lever or hold down plate. The Rittal International latch has a keeper mounted outwardly from the face of the rail. A positive lockout slide is carried on the assembly as part of a pivoting lever and engages the keeper when the lever is pivoted to the closed position (injected position) to secure the latch in the closed/locked position. Generic to PCI latches is a finger or thumb grasping space, which requires the lever assembly to have a higher profile.

PC card levers and pullers are provided by a number of manufacturers including Calmark Corp. (USA), Richco, Inc. (USA) and Southco, Inc. (USA). Calmark provides a part no. 107-20 PC card inserter-extractor latch. This is a one-piece lever, which is pinned to a PC card near its outside edge to enable it to pivot. The lever includes a snap-type detent foot, which engages a second pin extending through the card when the lever is in the downward/closed position. This engagement acts as a pressure or friction hold down. The lever has an upraised finger grasping end. The opposite end of the lever carries a pawl which engages a C-shaped housing or rack mounted flange which acts as the latch keeper. The lever is manually pivoted to the outward position to disengage pawl from the keeper. In doing so, the detent force is overcome.

Richco provides a part no. R1107 PC card inserter-extractor latch. This latch is similar in shape and function to the Calmark latch, and similarly mounted to pivot. An exception is that the Richco lever is without the detent foot or a second pin.

Southco provides a part no. 90-0-6503-11 PC card inject-eject latch. The Southco latch pivots on a rivet through the PC card positioned near its outside edge. The Southco latch has a very long handle, which is grasped by drawing a finger and thumb along the PC card to catch the handle. The handle is without a detent or other closed/locked position-holding structure. It is intended to seat down on the outside edge of a card when in the closed position. This Southco handle carried a pair of rounded foot extensions at its opposite ends which act as pawls to engage a curved spring flange which is rack or housing mounted. This engagement affects the injection and ejection functions of the latch.

In attempt to make smaller footprints for electronic component housings and racks, and to include more component modules in a smaller space as circuits become smaller, there is an ever increasing desire to pack PC cards, PC modules and the like closer together and with less housing clearance. It therefore has become desirable a card or module injection-ejection latch with a lower profile, and a narrower footprint (width) than now available. It is also desirable to provide this inject-eject latch with a positive lockout at the closed or lockdown position. It is further desirable to provide this inject-eject latch with a handle for pulling the card or module out of the housing or rack, when the handle includes a pop-up function.

In attempt to make smaller footprints for electronic component housings and racks, and to include more component modules in a smaller space as circuits become smaller, there is an ever increasing desire to pack PC cards, PC modules and the like closer together and with less housing clearance.

It therefore has become desirable to provide a card or module mounted inject-eject latch of lever style.

It is also desirable to provide such lever with a lower profile, and a narrower footprint (width) than now available.

It is further desirable to provide this inject-eject lever with a positive lockout at the closed or lockdown position.

It is additionally desirable to provide this inject-eject lever with a handle for pulling the card or module out of the housing or rack, when the handle includes a pop-up function.

It is also further desirable to provide an inject-eject lever that can compensate for or is otherwise unaffected by small variations in the positioning of the chassis or frame (keeper) flanges.

It is also additionally desirable to provide an inject-eject lever which would provide a more positive pop-open (spring-open) action.

### SUMMARY OF THE INVENTION

An object of the present invention is to provide a low profile, narrow footprint inject-eject lever type latch assembly for use with a rack or housing/chassis mounted PC board, and which seats closely thereon when the latch assembly is rotated closed. The latch has a positive lockout in the closed or rotated down position. The latch is released by a positive release action to cause a handle portion of the latch assembly to move outwardly to provide a grasping handle.

A further object of the present invention is to provide this latch assembly with a reduced number of parts.

A further object of a first aspect of this invention is to simplify the configuration of each component part.

A further object of a second aspect of this invention is to provide a slider-type catch and release mechanism, which slide action is biases to the lockout position, whereof the catch is manually slid to release.

An further object of a third aspect of this invention is when simplifying the configuration and component parts of the lever latch assembly there is a minimizing the of need for biasing springs.

An additional object of the third aspect of this invention is to provide a lever latch assembly which will operate to a closed position with minimal PC board clearance.

An even further object of the third aspect of this invention is to provide a lever latch assembly which will operate about equally well with variations in keeper (chassis flange) flange position.

These objects are realized in a PC board lever-type rotating latch assembly, which is mountable directly to a PC board at its outward edge to operate against a flange-type keeper mounted on the rack or chassis of the housing into which the PC board is to be mounted. Each PC board may have two lever latch assemblies, one mounted for pivoting at each outside corner of the PC board.

A keeper is positioned on or adjacent a rail into which the PC board is inserted, or on a housing wall adjacent the PC board, if appropriate and depending upon the assembly. The keeper is generally a C-shaped flange, such as a C-channel, which forms a three-side boxed area into which the lever latch assembly can rotate. The web member of the C-shaped flange is attached to the chassis-mounting surface, with the upper or outer flange extending towards the PC board and the bottom or inner flange extending parallel to the upper flange and towards the PC board.

In the first aspect of the invention, the assembly includes a pivoting one piece lever which has a finger grasp handle at one end and a projecting tongue at the other end. The lever is mounted adjacent the PC board card edge to rotate on a pin projecting through the PC board (PC card). The lever is positioned with its tongue facing the side edge of the card and the handle facing the middle of the card. At least one preferably two projecting flanges project transversely away from the handle to be orthogonal to the handle's longitudinal axis. Each flange has a hole aligned with the other which acts as a journal in connection with the card mounted pin, thereby permitting each flange to pivot about the pin, which thereby establishes the pivot point for the lever.

When the PC board installation is vertical, the lever pivots between the horizontal position when it is closed, i.e., in a locked down position, and the vertical position, when fully opened for the PC board removal. The open side of the C-shaped keeper flange faces the card edge of the side of the PC board, with the free extending flange portion with the squared-off edge at the outboard side. The keeper flange can be mounted in reverse order equally as well, if the housing or rack permits the securing of the keeper mounting surface in that reverse (upward) position.

The keeper is positioned away from the card edge side sufficiently to permit the lever to pass when in the fully open (vertical) position. The lower the profile of the lever, the less spacing is needed, the smaller the boxed in area of the flange needs to be, and the smaller the projection of the tongue portion of the lever needs to be.

The handle area of the lever carries a pivot mount. A catch member is mounted for rotation on that handle pivot mount whereby it is carried on the lever for movement relative thereto. This catch member includes at least one and preferably two projecting feet, which project adjacent the tongue, in the same direction as the tongue, and essentially in parallel projection to the tongue.

The lever carries a biasing spring that operates between the lever and the card edge to bias the lever to a rotated position way from the card edge. The catch carries a biasing spring that operates between the catch and the lever to bias the catch in a position away from the lever.

In operation, a PC card is inserted into a rack or housing using the handle end of the lever which is extending upwardly way from the card edge. Once the PC board is inserted to have its connector begin to engage the housing connector, the lever has passed by the keeper flange to have its tongue juxtaposed to the open side of the boxed region of the C-shape of the flange. The handle is pressed into the card edge moving the tongue into the boxed region to have the tongue press against the inside (bottom) side of the keeper's free flange projection. This force injects the connector into its mating part and thereby positively injects the PC board to seat its mounting. When the lever has been manually fully closed, with the handle portion seated against the card edge, the tongue is flat against the keeper flange bottom face, and the projecting feet on the catch will have ridden over the end of the flange projection to provide a force against the squared-off edge of the flange projection. This will provide a positive lockout of the lever. Any attempt to pull the lever handle away from the card edge will be resisted by the catch feet, and thereby lock the lever down.

To release the lever for movement (rotational movement), the catch is depressed towards the lever, in a motion depressing its biasing spring. This movement causes the catch feet to move below the end of the flange projection to remove the lockout. With the catch feet dislocated from the end of the flange, the lever is free to rotate open under its biasing spring force. The lever biasing spring is long enough to rotate the lever sufficiently for its handle portion to be easily grasped by a finger and thumb. The lever is then manually fully rotated to a position parallel to the card edge adjacent the keeper to permit a clearance for pull the PC board out of its mounting.

In the second aspect of the invention, the assembly includes a pivoting one-piece lever, mounted to straddle the outer edge of the PC board (or PC card) and pined to the board for pivoting with respect thereto. The lever has a finger grasp handle at one end and a projecting blade-type tongue at the other end. The lever mounting position is adjacent the PC board (card) side edge in order to rotate into and out of the box shape of the C-channel keeper. The lever is positioned with its tongue facing the side edge of the board (card) and the handle facing the middle of the board (card). A coil-type compression spring is carried between the board (card) edge and the bottom of the handle whereof it seats into a socket on the bottom face thereof. This spring biases the handle upwardly (outwardly) from the board (card) edge.

The lever has at least one, preferably two projecting flanges, position at the body of the handle and inboard from the tongue, with each extending transversely away from the body of the lever handle and orthogonal to the handle longitudinal axis. Each flange has a juxtaposed hole, in alignment with each other and to act as a journal for a board (card) mounted through-pin, thereby permitting each flange and the lever to pivot about this through-pin which is the handle pivot pin. The location of the handle pivot pin establishes the pivot point for the lever.

When the PC board installation is vertical, the lever pivots between the horizontal position when it is closed, i.e., in a locked down position, and the vertical position, when fully opened for the PC board removal.

The keeper is spaced away from the board (card) side edge sufficiently to permit the lever to pass when in the fully open (vertical) position. The lower the profile of the lever, the less spacing is needed, the smaller the boxed in area of the flange needs to be, and the smaller the projection of the tongue portion of the lever needs to be.

A catch member is mounted for sliding along the handle and is held by the action of the handle pivot pin. This slide catch member includes at least one and preferably two projecting feet, which project adjacent the tongue, on the outboard side thereof, and in the same direction as the tongue. The slide catch projecting feet are each in parallel projection to the tongue.

The side catch carries a biasing spring that operates between the catch and the lever handle to bias the catch in a position away from the lever handle and outwardly to about the end of the tongue. This slide catch spring is a coil-type compression spring that seats against a shoulder on the lever handle and a shoulder on the catch. Both the catch walls and adjacent lever projection flange walls carry slots to accommodate and retain the slide catch biasing spring.

In operation, a PC card is inserted into a rack or housing using the handle end of the lever which is extending upwardly way from the card edge. Once the PC board (card) is inserted to have its connector begin to engage the housing connector, the lever has passed by the keeper flange to have its tongue juxtaposed to the open side of the boxed region of the C-shape of the flange. The handle is pressed into the board (card) edge moving the tongue into the boxed region to have the tongue press against the inside (bottom) side of the keeper's top flange projection. This force injects the connector into its mating part and thereby positively injects the PC board to seat its mounting.

As the handle is rotated into a seating position on the board (card) edge the projecting feet of the slide catch come in contact with the bottom flange projection of the keeper. The catch is moved towards the handle as the catch biasing spring is compressed by the contact of the catch with the keeper flange. This permits the catch to clear the keeper. Once the slide catch clears the bottom flange of the keeper it is free to move to its fully extended position adjacent the extension of the tongue.

When the lever has been manually fully closed, with the handle portion seated against the card edge, the tongue is in contact with the keeper top flange inside face, and the projecting feet on the catch are in contact with the keeper bottom flange inside face. This results in a securely held PC board (care) and provides provide a positive lockout of the lever. Any attempt to pull the lever handle away from the card edge will be resisted by the catch feet, and thereby lock the lever down.

To release the lever for movement (rotational movement), the catch is manually slid towards the lever handle, in a motion depressing the catch biasing spring. This movement causes the catch feet to move out of the C-channel and beyond the extended outer edge of the keeper bottom flange. While an operator's fingers are still on the slide catch, the lever handle will begin to rotate upwardly away from the board (card) edge under the force of the lever handle biasing spring. The lever handle biasing spring is of a size to rotate the lever sufficiently for its finger handle to be easily grasped by a finger and thumb. The lever is then manually fully rotated to a position parallel to the board (card) edge adjacent the keeper to permit a clearance for pulling the PC board out of its mounting.

In the third aspect of the invention, the latch assembly includes a pivoting two-piece lever, mounted to straddle the outer edge of the PC board (or PC card) and pinned to the board for pivoting with respect thereto. The lever has a finger grasp handle portion at one end and a projecting footed-type tongue at the other end. This two-piece lever has its handle portion facing away from the adjacent side edge of the PC board. The footed tongue (pawl portion) is mounted on the handle for rotation between those two pieces. The handle, in turn, rotates with respect to the outer edge of the PC board.

When inserting and locking a PC board into position, the two-piece lever is first rotated to be parallel with the side edge of a PC board, and thereby provides a grasp for inserting the PC board into its chassis slot. As the PC board is near fully seated, the footed tongue is adjacent the chassis keeper and the two-piece lever is rotated down onto the outside edge of the PC board. As a result, the tongue (pawl) engages a projecting flange of the adjacent chassis keeper and as the lever is further moved onto the PC board outer edge, the abutment of the tongue (pawl) against the keeper forces the lever and therefore the PC board into the slot. This action completes the injection of the PC board into its chassis slot and the lever locks into the keeper.

Proximate the tongue (pawl) mounting area on the handle is a handle abutment shoulder against which an abutment shoulder of the tongue becomes seated, thereby fixing the tongue in alignment with handle. In this position, the chassis mounted keeper flange is fully engaged by the tongue, which is in a fixed position with respect to the handle, and the latch is locked into a closed position in contact with the outer edge of the PC board.

The handle width exceeds the width of the PC board and the underneath of the handle is slotted to sit over the PC board edge. This configuration permits the handle to sit down flush on the outside edge of the PC board when in the locked position.

A finger-operated button is positioned on a cantilevered tab extending from the back of the tongue (pawl). In the closed and locked position, the free end of the cantilever tab abuts an edge on the handle to create a “pinch point”. This pinch point engagement creates a friction for fixing the aligned position of the handle and tongue and also provides a forward pressure which seats the tongue abutment shoulder against the handle abutment shoulder. This tab acts as a catch mechanism for holding the two pieces fixed with respect to one another and inhibiting any rotation there between.

When the button is manually depressed, the cantilever tab flexes and moves to release the pinch point, i.e., moves the cantilever downwardly from this release point with the handle, and begins to rotate the attached tongue. With the aid of a single biasing spring positioned to bias them rotated apart, the handle than rotates away from the fixed alignment position with the tongue (pawl). This withdraws the handle abutment shoulder from its abutment position against the tongue abutment shoulder. The action also pivots the two pieces, i.e., rotates the two parts of the ejector lever with respect to one another. The tongue (pawl) is released from its engagement with a chassis keeper flange and the handle is rotate upwardly from being seated on the edge of the PC board. This makes the handle available for grasping.

The lever is then free to be further rotated upwardly or outwardly with the handle extending outwardly from the outward edge of the PC board. Thereafter the PC board can be manually withdrawn from its chassis slot using the handle grasps.

### BRIEF DESCRIPTION OF THE DRAWINGS

The features, advantage and operation of the present invention will become readily apparent and further understood from a reading of the following detailed description with the accompanying drawings, in which like numerals refer to like elements, and in which:

FIG. 1 is a side view of a prior art Rittal inject-eject module latch with positive lockout plate, mounted on the end rail of a module;

FIG. 2 is a plan view of the prior art Rittal latch of FIG. 1;

FIG. 3a is a perspective view of a prior art Calmark PC card latch;

FIG. 3b is a side view of the prior art Calmark latch of FIG. 3a with the chassis flange keeper;

FIG. 4a is a side view of a prior art Richco claw-type pawl PC card latch;

FIG. 4b is an end view of latch of FIG. 4a;

FIG. 4c is a side view of the prior art Richco latch of FIG. 4a engaging a chassis flange keeper;

FIG. 5a is a side view of a prior art Richco tongue-type pawl PC card latch;

FIG. 5b is an end view of the prior art latch of FIG. 5a;

FIG. 5c is a side view of the prior art Richco latch of FIG. 4a engaging a chassis flange keeper;

FIG. 6a is a side view of a prior art Southco PC card inject-eject latch closed down on a card edge;

FIG. 6b is a top view of the latch of FIG. 6a;

FIG. 6c is a partial close-up view of the Southco latch about to engage a curved spring-type chassis keeper;

FIG. 6d is a partial close-up view of the latch of FIG. 6c fully engaged with the curved spring-type keeper;

FIG. 6e is a partial close-up view of the Southco latch about to engage a transverse mounted double spring-type chassis keeper;

FIG. 6f is a partial close-up view of the latch of FIG. 6e fully engaged with with the double spring-type chassis keeper;

FIG. 7a is a perspective view of the lever latch assembly of the first aspect of the present invention;

FIG. 7b is a top view of the lever latch assembly of FIG. 7a;

FIG. 7c is a bottom view of the lever latch assembly of FIG. 7a;

FIG. 7d is an end view of the lever latch assembly of FIG. 7a;

FIG. 7e is a side view of the lever latch assembly of FIG. 7a;

FIG. 8a is a perspective view of the lever member of the lever latch assembly of FIG. 7a;

FIG. 8b is a top view of the lever member of FIG. 8a;

FIG. 8c is a bottom view of the lever member of FIG. 8a;

FIG. 8d is an end view of the lever member of FIG. 8a;

FIG. 8e is a side view of the lever member of FIG. 8a;

FIG. 9a is a perspective view of the catch member of the lever latch assembly of FIG. 7a;

FIG. 9b is a top view of the lever member of FIG. 9a;

FIG. 9c is a bottom view of the lever member of FIG. 9a;

FIG. 9d is an end view of the lever member of FIG. 9a;

FIG. 9e is a side view of the lever member of FIG. 9a;

FIG. 10 shows a side view of the lever latch assembly of the first aspect of invention mounted on a PC board outer edge and partially engaging a flange-type chassis keeper;

FIG. 11 shows a side view of the lever latch assembly of FIG. 10 closed and locked onto the chassis keeper;

FIG. 12 shows a side view of the lever latch assembly of FIG. 10 rotating open under its spring biasing following the release of the catch;

FIG. 13 shows a side view of the lever latch assembly of FIG. 10 fully open;

FIG. 14 shows a side view of the lever latch assembly of FIG. 10 during PC board (card) insertion with the clearance for chassis flange spacing;

FIG. 15 shows a side view of the lever latch assembly of FIG. 10 before rotating open, but with the catch depressed;

FIG. 16 shows a side view of the lever latch assembly of FIG. 10 in the biased open position prior to the manual opening of the lever and removal of the PC board;

FIG. 17 is a close-up top view of the lever latch assembly of FIG. 10 partially engaging the chassis keeper;

FIG. 18 is a sectional side view of the lever latch assembly of FIG. 10 partially engaging the chassis keeper taken as shown in FIG. 17;

FIG. 19 is a close-up top view of the lever latch assembly of FIG. 10 in the fully closed and lockout position with respect to the keeper;

FIG. 20 is a sectional side view of the lever latch assembly of FIG. 10 fully closed and lockout position taken as shown in FIG. 19;

FIG. 21 a close-up top view of the lever latch assembly of FIG. 10 with the catch released and the assembly ready to rotate clear of the chassis flange lockout position; and

FIG. 22 is a sectional side view of the latch assembly of FIG. 10 in the catch released taken as shown in FIG. 21.

FIG. 23 is a side view of a PC board (card) with the second aspect of the lever latch assembly in the fully upright (outward) position for clearing a chassis keeper when the board is inserted into a rack or housing;

FIG. 24 is a side view of the assembly of FIG. 23 which has cleared the keeper upon partial insertion and a catch wall is in contact with the keeper upper flange;

FIG. 25 is a side view of the assembly of FIG. 23 with the handle partially rotated down and the catch beginning to retract;

FIG. 26 is a side view of the assembly of FIG. 23 with the handle fully rotated down to seat against the board (card) edge and the catch fully extended to lock into the keeper;

FIG. 27 is a side view of the assembly positioned as in FIG. 26, but with the catch retracted out of the keeper by being manually slid towards the handle;

FIG. 28 is a side view of the assembly of FIG. 23 as it is rotated upward (outward) from the board (card) edge under the operation of the lever handle biasing spring;

FIG. 29 is a side view of the assembly of FIG. 23 which is has begun the ejection operation as the tongue acts against the keeper bottom flange, as the finger handle is rotated into the upright position;

FIG. 30 is a perspective view of the assembly shown in FIGS. 23-29;

FIG. 31 is an enlarged side view of the assembly of FIG. 23 with the latch (and PC board) in the fully seated and locked out position;

FIG. 32 is a top view of the assembly of FIG. 23 positioned as shown in FIG. 31;

FIG. 33 is a partial side cross sectional view taken as shown in FIG. 32;

FIG. 34a is a perspective view of the assembled latch of the present invention of FIG. 23;

FIG. 34b is a top view of the assembled latch of FIG. 34a;

FIG. 34c is a side view of the latch of FIG. 34a;

FIG. 34d is a tongue end view of the latch of FIG. 34a;

FIG. 34e is a handle end view of the latch of FIG. 34d;

FIG. 35a is a perspective view of the lever, handle and tongue member of the latch of FIG. 23;

FIG. 35b is a top view of the lever of FIG. 35a;

FIG. 35c is a side view of the lever of FIG. 35a;

FIG. 35d is a tongue end view of the lever of FIG. 35a;

FIG. 35e is a handle end view of the lever of FIG. 35a;

FIG. 36a is a perspective view of the side slide catch member of the latch of FIG. 23;

FIG. 36b is a top view of the slide catch of FIG. 36a;

FIG. 36c is a side view of the slide catch of FIG. 36a;

FIG. 36d is a projecting feet end view of the slide catch of FIG. 36a;

FIG. 36e is a flange end view of the slide catch of FIG. 36a;

FIG. 37 is a perspective partial view of the third aspect of the invention that being a split ejector lever latch assembly engaging a chassis keeper when closed down on a PC board;

FIG. 38 is a side view of the split ejector latch assembly of FIG. 37 with the lever handle partially raised;

FIG. 39 is a side view of FIG. 37 showing the latch assembly locked down onto the PC board;

FIG. 40 is a top view of the locked down latch assembly of FIG. 39;

FIG. 41a is a side view of a PC board with the latch assembly of FIG. 37 being rotated outwardly for installation of the PC board into its slot and past a chassis keeper;

FIG. 41b shows the pawl member upstanding shoulder engaging the top of the keeper flange to force a rotation of the assembly of FIG. 41a;

FIG. 41c shows the assembly of FIG. 41a with the PC board further inserted and the lever handle being rotated downwardly thereby engaging the pawl foot against the bottom of the keeper flange for injection of the PC board;

FIG. 41d shows the latch assembly of FIG. 41a locked down on the PC board and the pawl fully engaging the chassis keeper;

FIG. 41e shows assembly of FIG. 41a with the lever handle popped open when the release button is pushed;

FIG. 41f shows the assembly of FIG. 41a with the lever handle being rotated upwardly open for performing the eject operation and for thereafter releasing the pawl from the keeper in preparation for pulling the PC board out of the slot;

FIG. 42 is a cross-sectional view of the latch assembly of FIG. 37 locked down on a PC board taken as shown in FIG. 40;

FIG. 43 is a top view of the partially popped open lever handle and latch assembly of FIG. 41e;

FIG. 44 is a cross-sectional view of the latch assembly with the partially popped open lever handle taken as shown in FIG. 43;

FIG. 45a is a perspective view of the two-piece split ejector latch of the assembly of FIG. 37;

FIG. 45b is a top view of the two-piece split ejector latch of FIG. 45a;

FIG. 45c is a side view of the latch of FIG. 45a;

FIG. 45d is a pawl end view of the latch of FIG. 45a;

FIG. 45e is a handle end view of the latch of FIG. 45a;

FIG. 46a is a perspective view of the handle (lever) member of the two-piece split ejector latch showing the pawl journal bosses and the grasping portion regarding the assembly of FIG. 37;

FIG. 46b is a top view of the handle member of FIG. 46a;

FIG. 46c is a side view of the handle of FIG. 46a;

FIG. 46d is a pawl end view of the handle of FIG. 46a;

FIG. 46e is a grasping end view of the handle of FIG. 46a;

FIG. 47a is a perspective view of the pawl (tongue member) of the two-piece split ejector latch showing the keeper engaging foot and the catch mechanism release button tab regarding the assembly of FIG. 37;

FIG. 47b is a top view of the pawl of FIG. 47a;

FIG. 47c is a side view of the pawl of FIG. 47a;

FIG. 47d is a foot end view of the pawl of FIG. 47a; and

FIG. 47e is a button cantilever tap end view of the pawl of FIG. 47a.

### DETAILED DESCRIPTION OF THE INVENTION:

The present invention is an improved PC board mounted ejector lever, which includes a lever latch assembly having a chassis engaging pawl and a positive lockout to secure the fully closed position against accidental opening. In the first and second embodiments, the assembly assists in the injection and ejection of the PC board into its housing or chassis mounting and the removal there from, respectively, including a positive connector engagement and disengagement. The present invention also has a reduced parts count, reduced size and weight while providing an outwardly biased pop-out handle to assist in PC board removal. A push button-type operation facilitates this pop-out operation. The third embodiment includes the same PC board inject and eject functions but incorporates a split ejector lever having two major components, a chassis engaging pawl (tongue) and a handle (lever). This feature allows lever rotation for grasping by splitting the front end (the pawl) and the back end (the lever/handle) of the ejector. The split ejector results in a more simplified assembly, a more robust prying end of the ejector, and provides an ejector structure which does not depend upon the PC board edge or a chassis keeper flange for its catch or popping open functions needed for handle grasping.

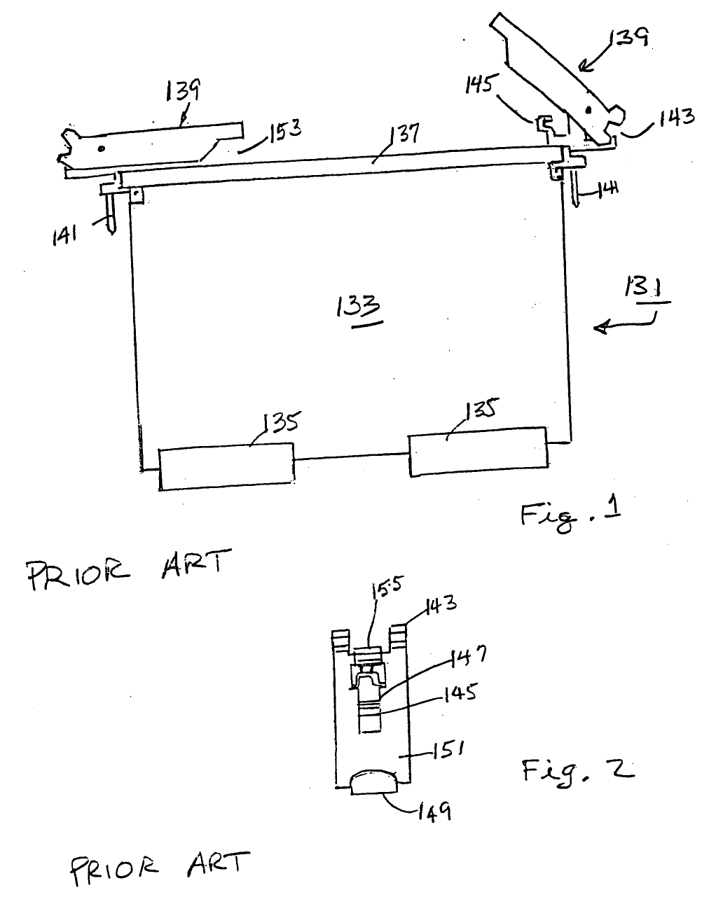

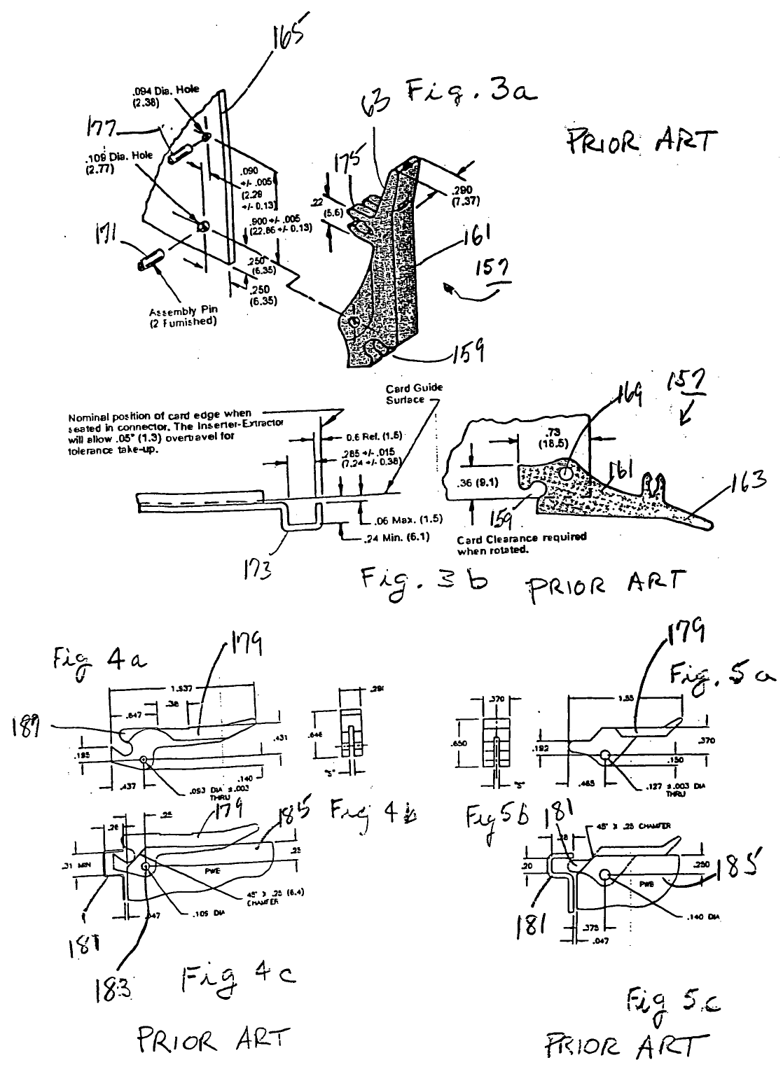

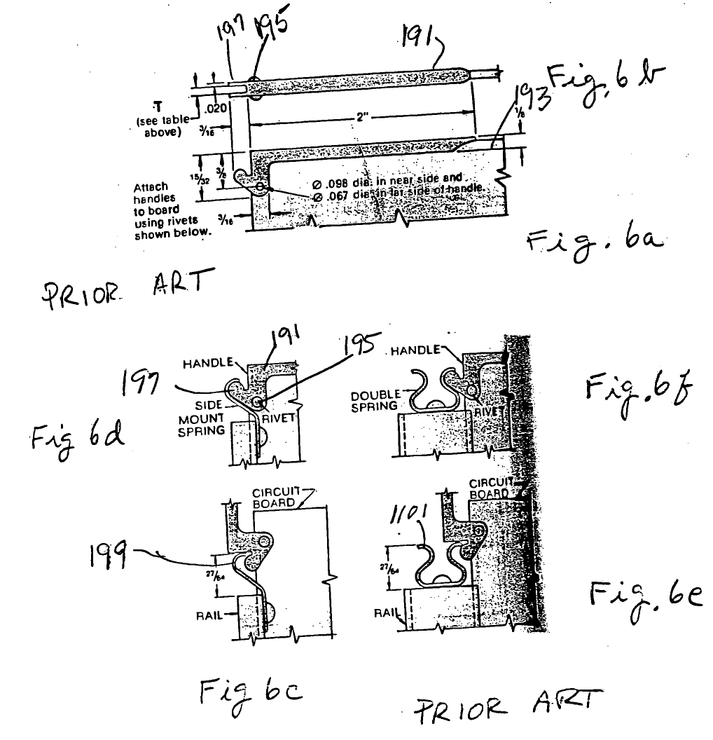

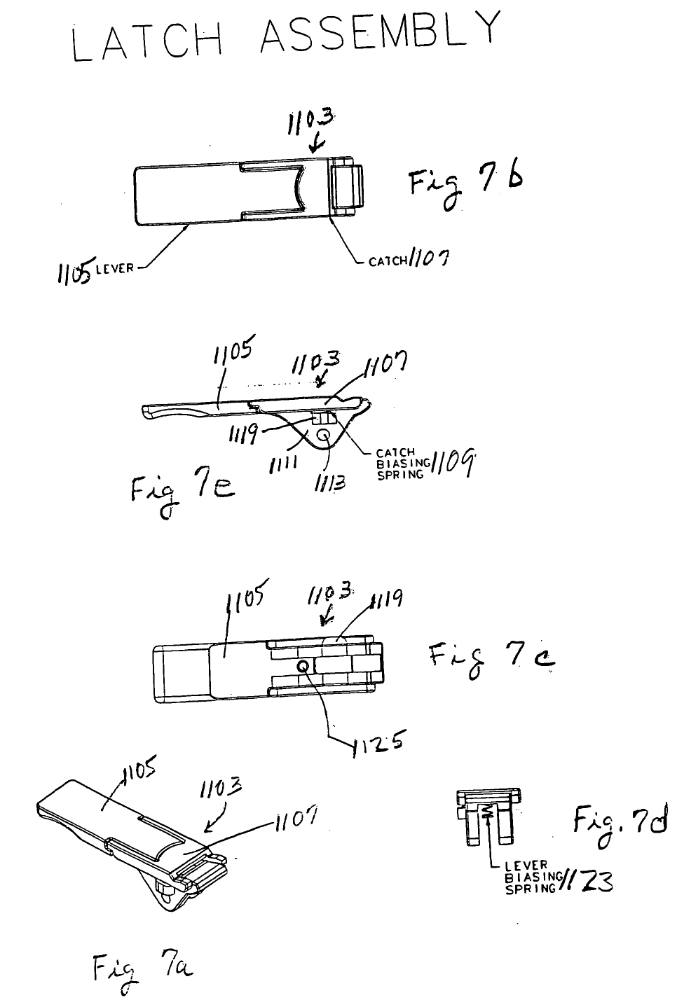

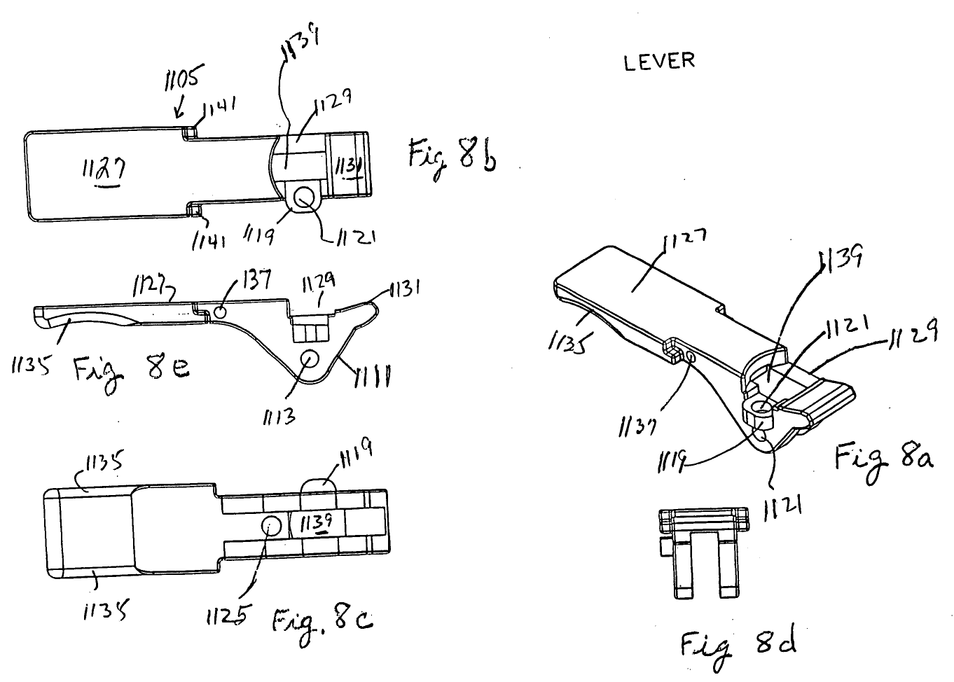

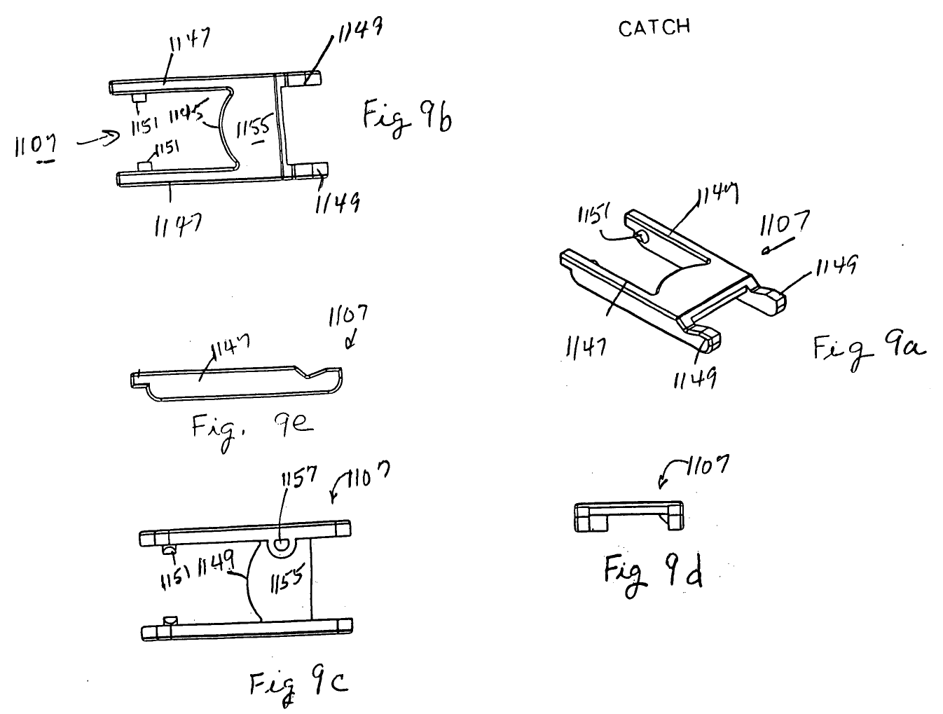

The prior art has provided a number of PC board inject-eject lever-type latches some with pop-out functions, and others without. FIG. 1 shows an assembly of a PC board module 131 having a PC board 133 with connectors 135 and an outer rail 137. Mounted on each side of the module, at the outside corner is a commercially available Rittal International inject-eject lever assembly 139. With most PC board mountings, the board/card latches are mounted in pairs.

The Ritall device engages a guide pin 141 to assist in the alignment of his connectors 135 on insertion and ejection. A claw type pawl 143 is used to engage the chassis. A C-shaped lockout hook 145 is engaged by a spring-biased lockout slide plate 147. This lockout slide plate 147 has a protrusion 149 beyond the end of the lever handle 151. The handle 151 is generally raised to provide a finger grip space 153. A flat coil spring 155 includes a protrusion that biases the handle 151 to the open position, and the lockout plate 147 against the lockout hook 145.

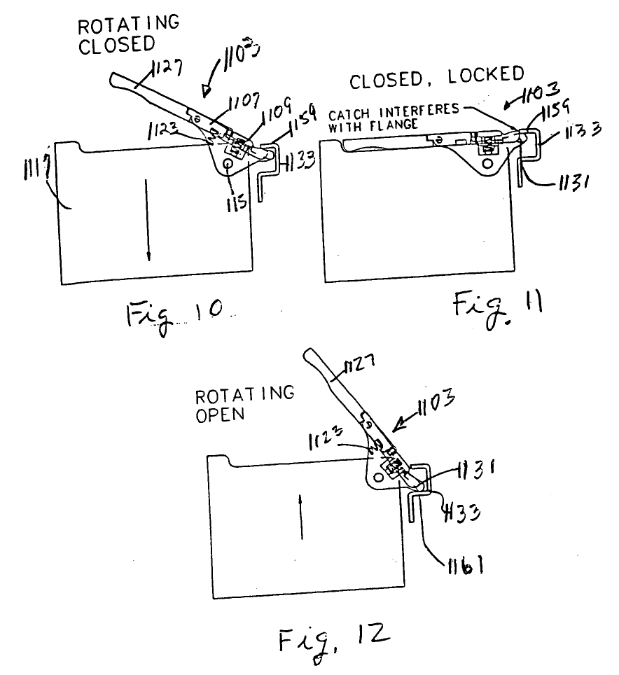

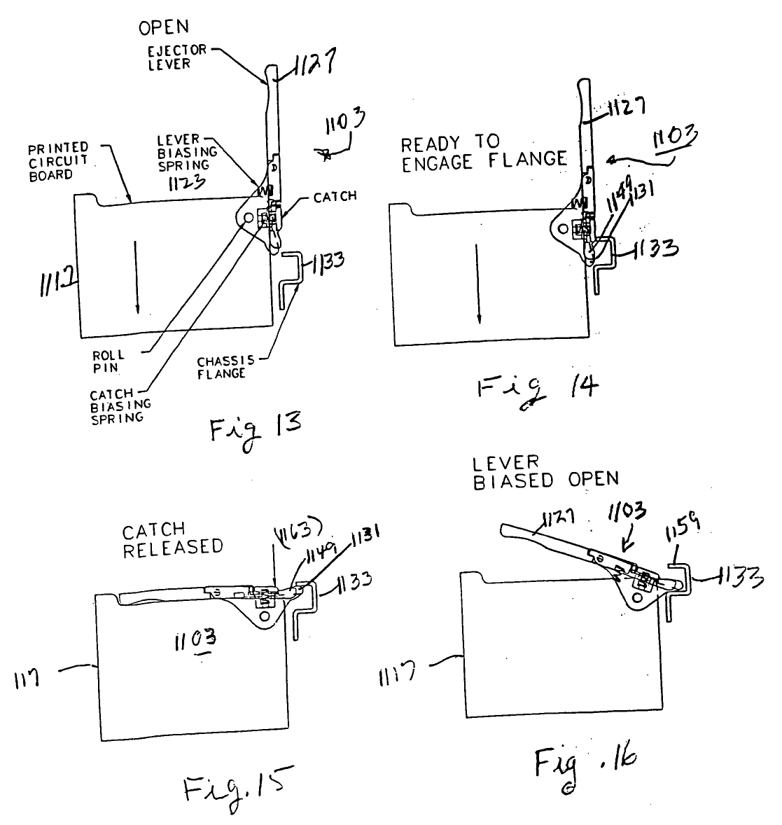

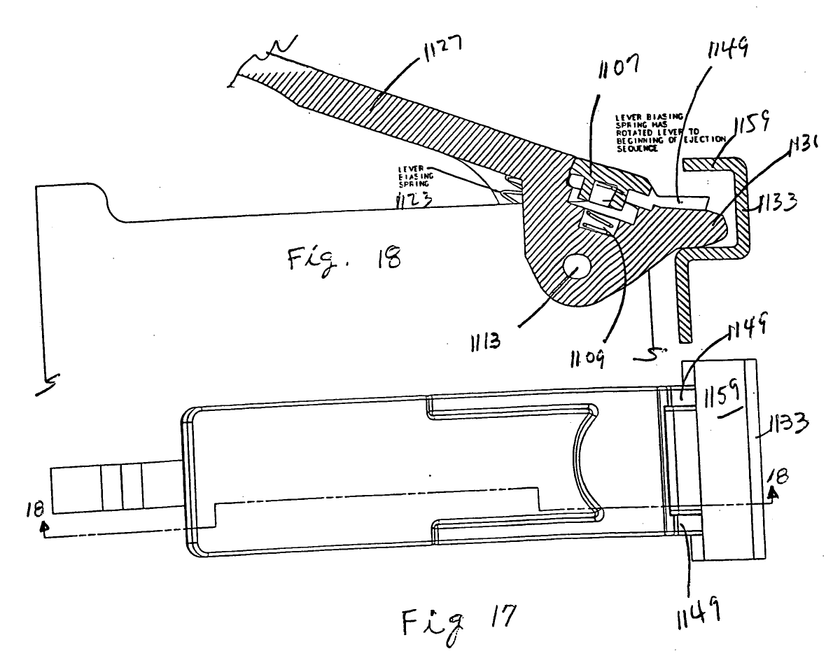

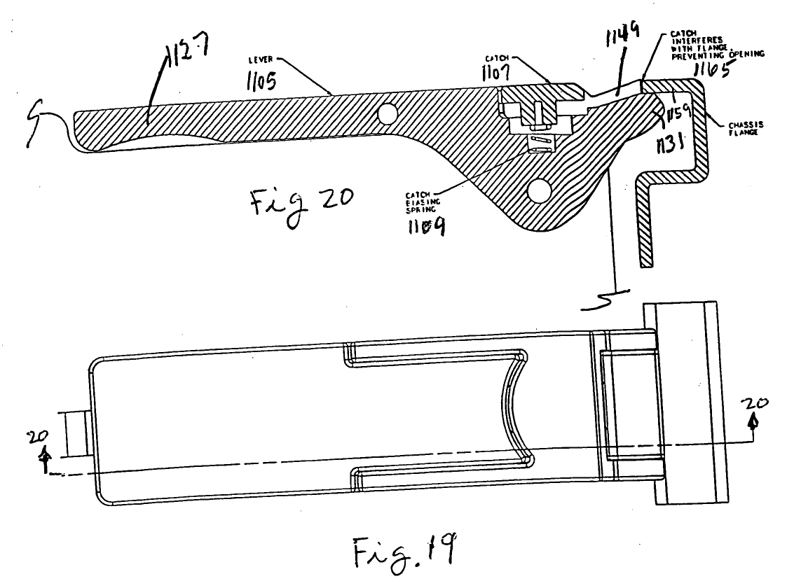

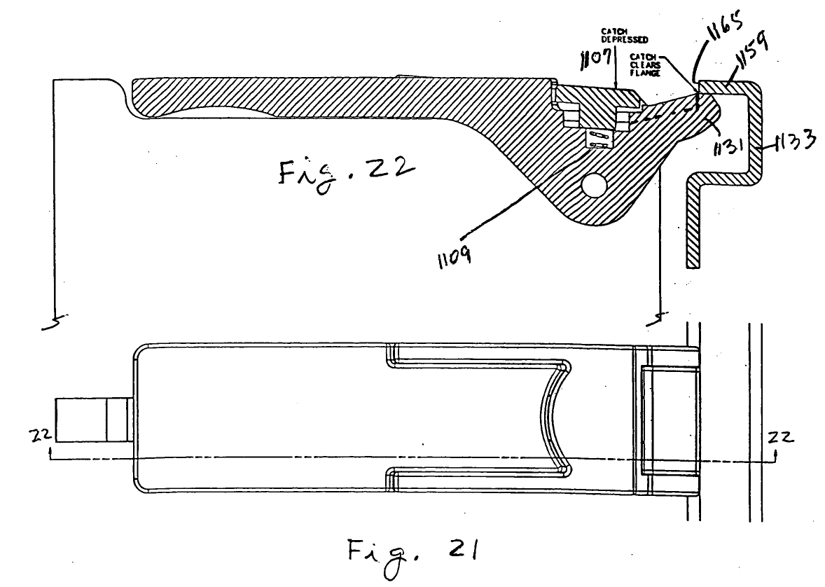

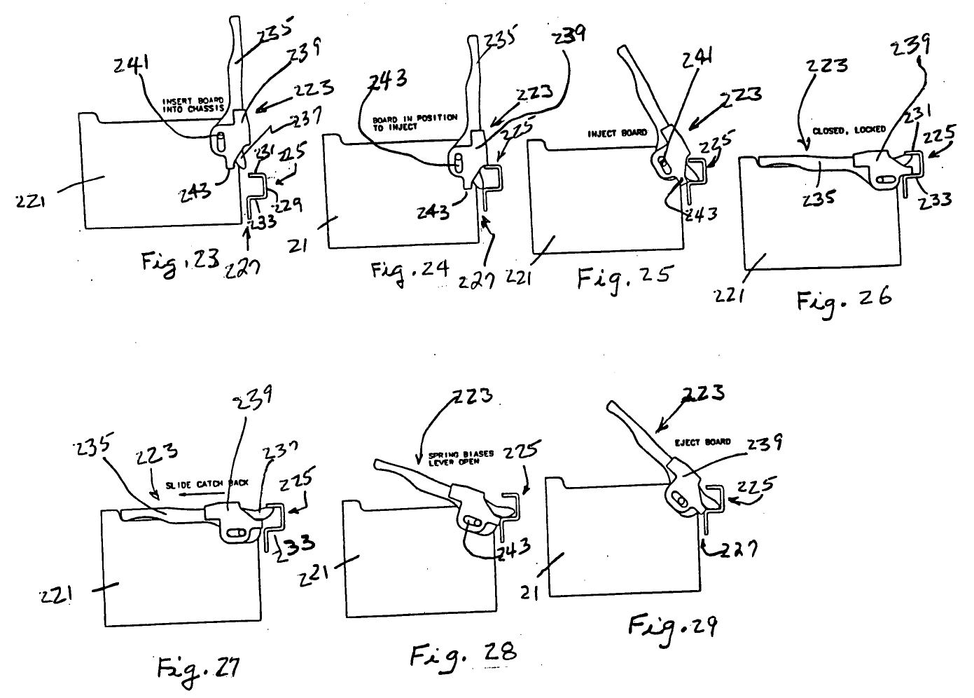

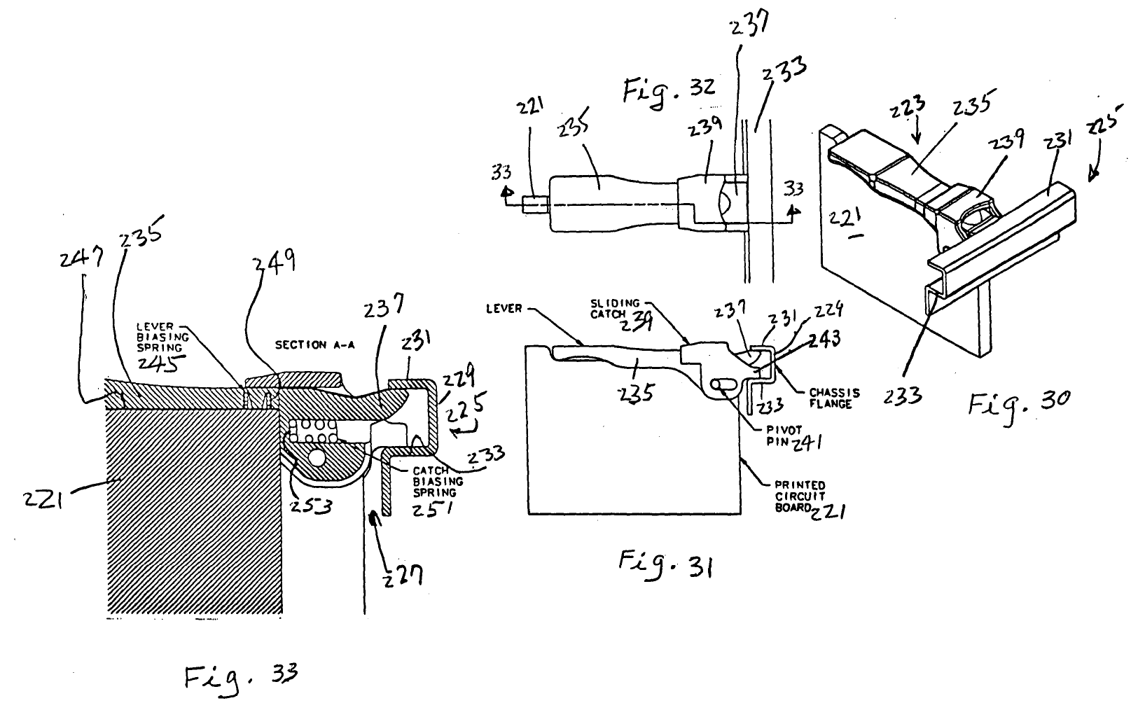

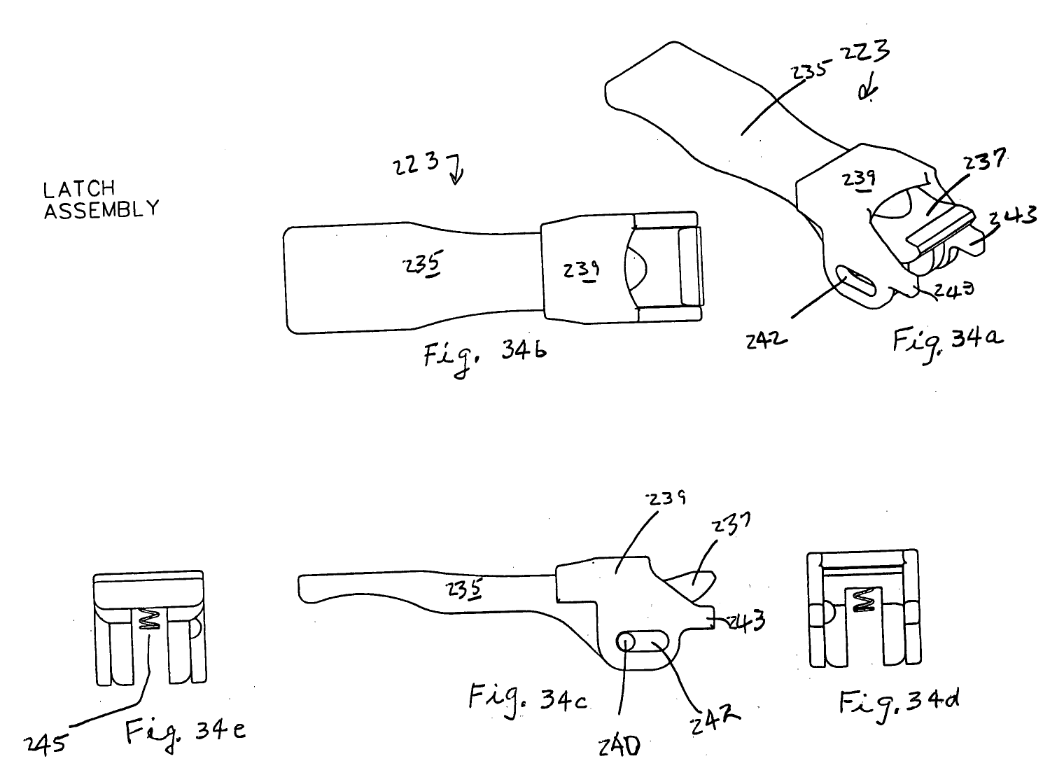

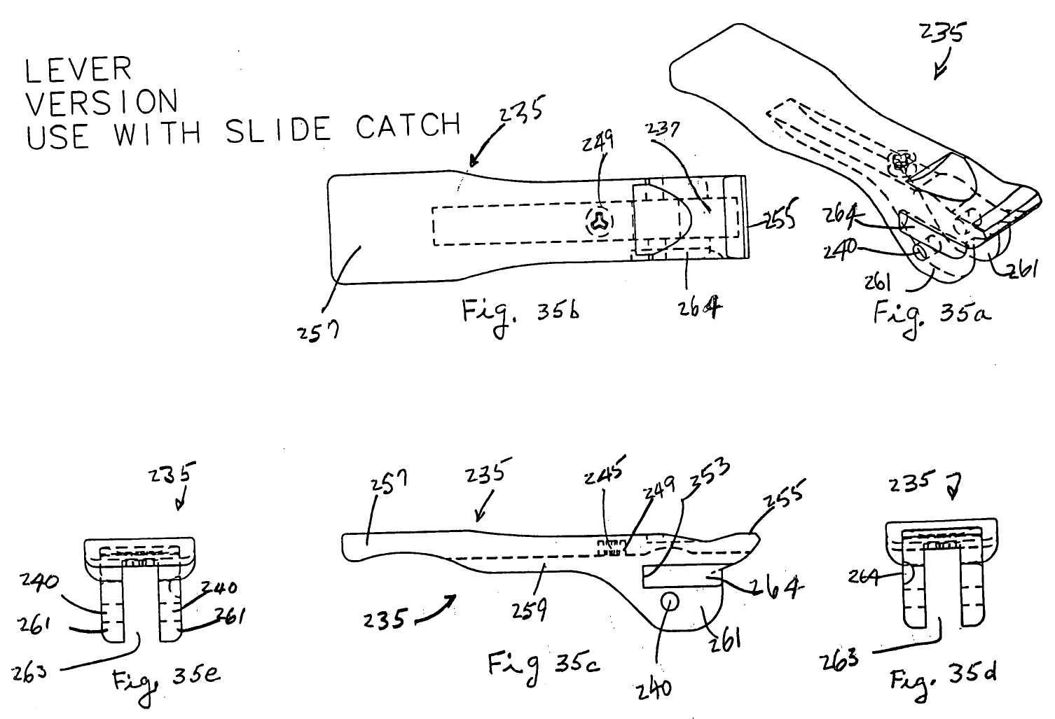

Also commercially available is the Calmark, Inc. PC card extractor 157, FIGS. 3a, 3b. This extractor 157 includes a claw-type pawl 159 at one end of an elongate lever 161. The lever 161 has a raised handle 163 that provides a finger grip spacing when the extractor 157 is closed down on the PC card 165 edge. The lever 161 includes a pair of juxtaposed projecting journal plates 167 each of which carry a hole 169 on which the lever 161 pivots when mounted to the card 165 with a pivot pin 171. The claw 159 rotates to engage a C-shaped chassis flange keeper 173. The lever also includes a pair of detent feet 175 which engage a second pin 177 mounted through the card 165. These detent feet act as a lockout to keep the lever in the closed position. However, as the detent force is the lockout force, and any pull on the lever sufficient to over come this detent force will free the lever 161, the Calmark device does not have a positive lockout.

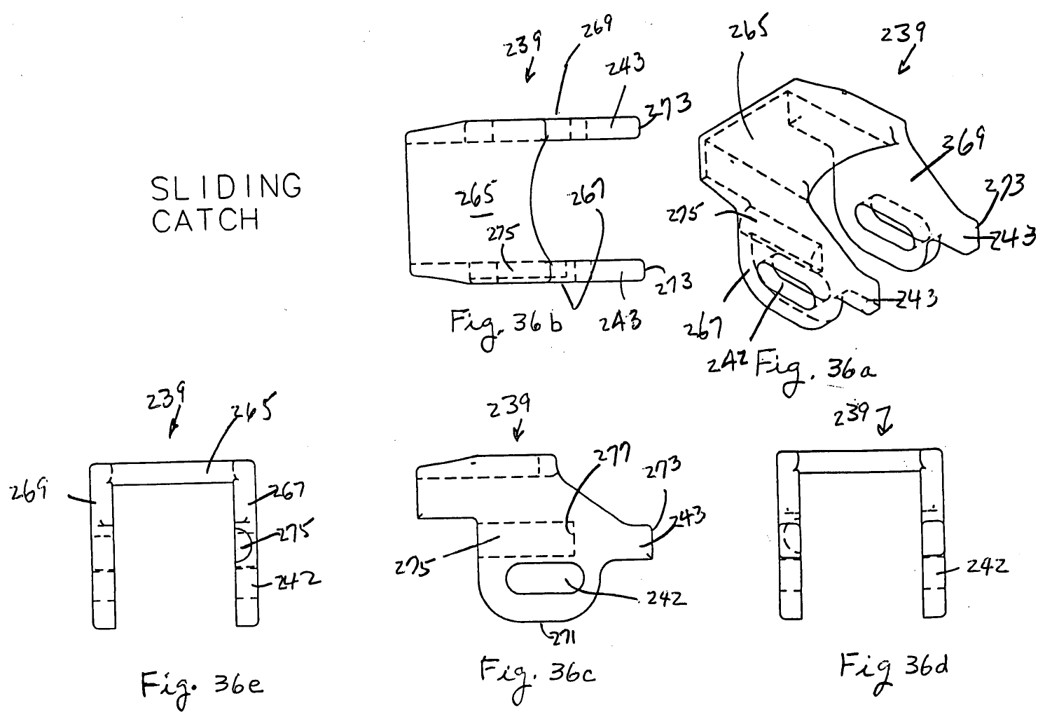

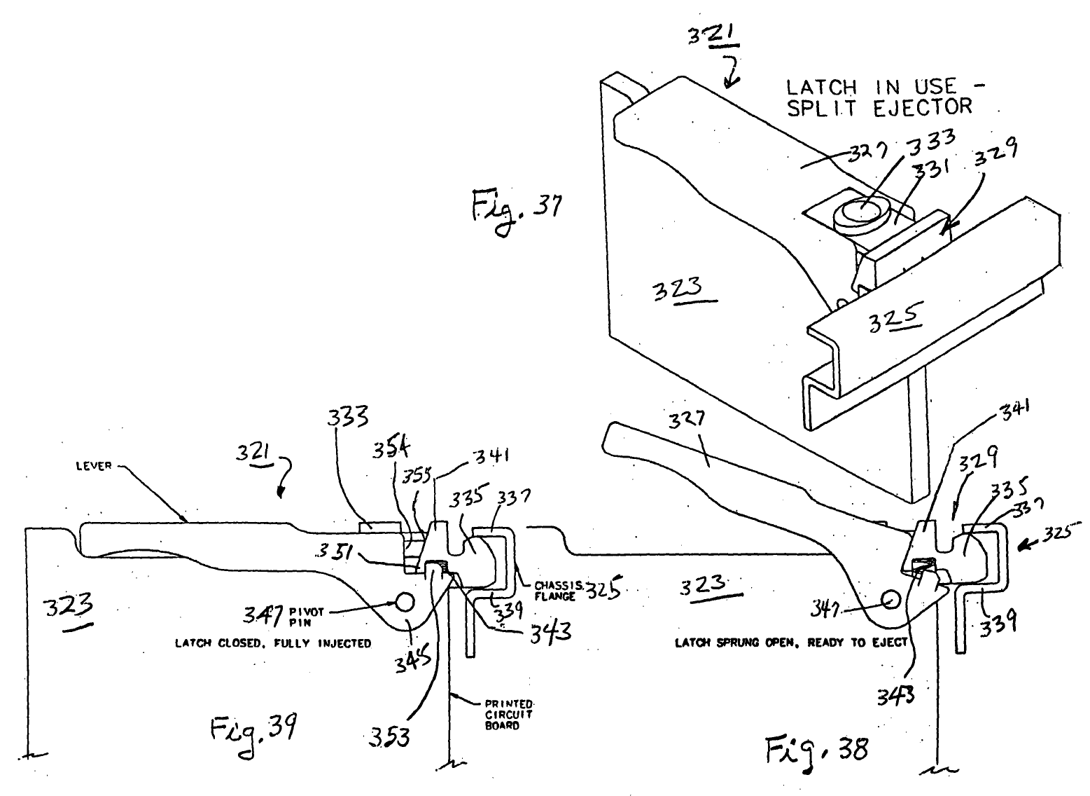

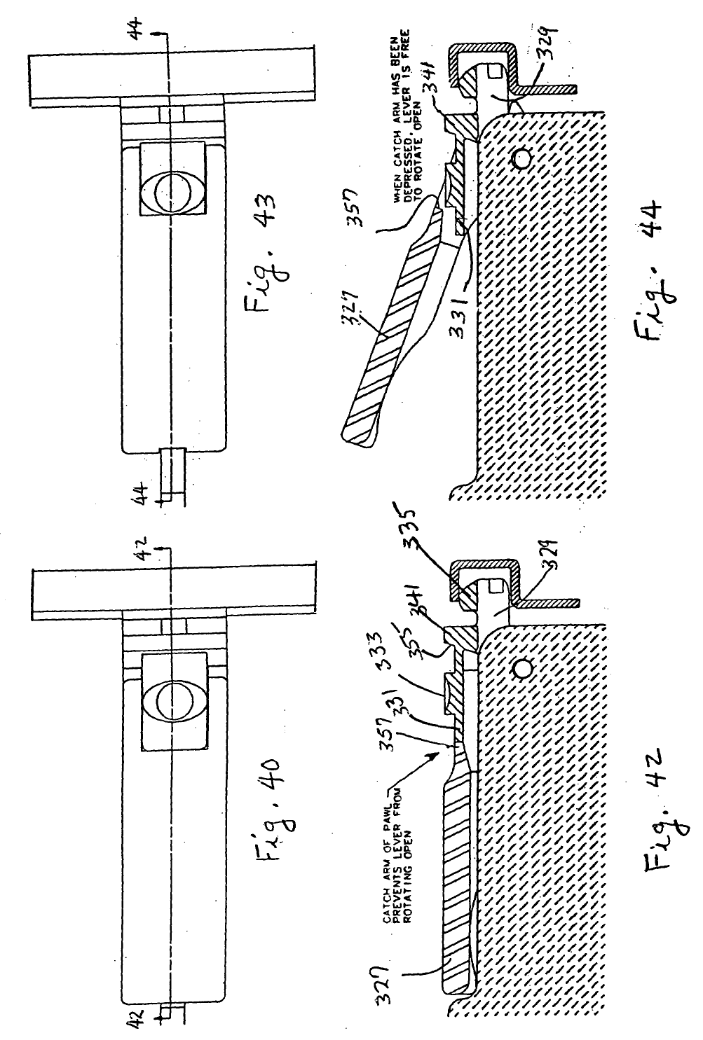

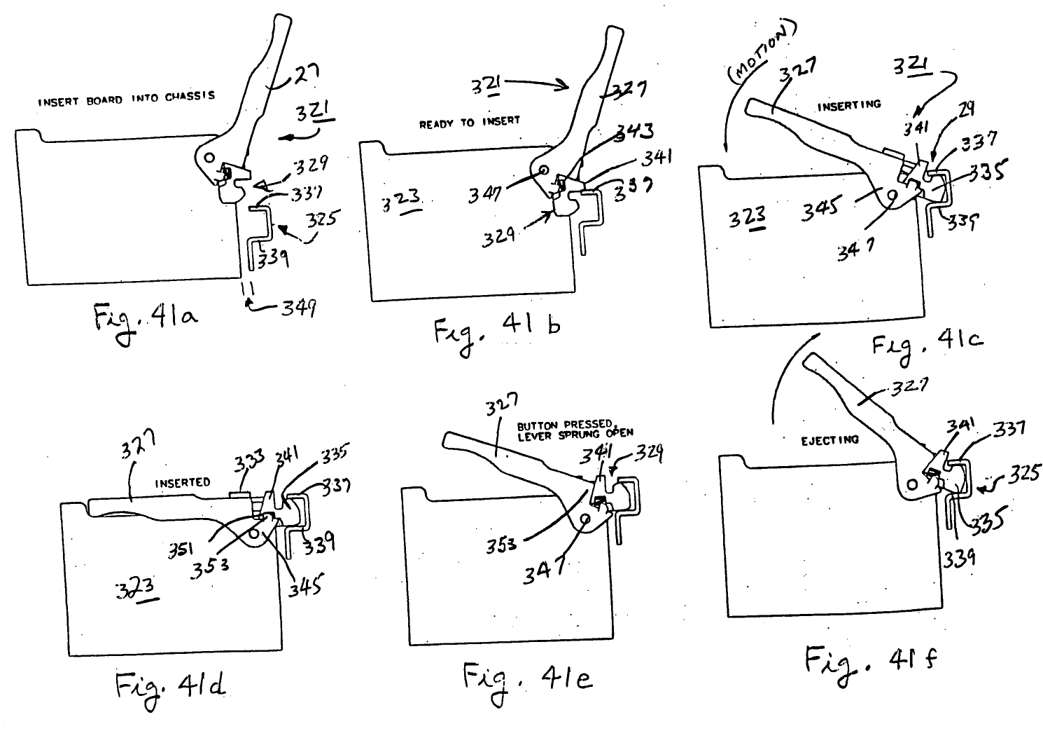

Richco Inc. has provided a commercial PC card latch, 179, FIGS. 4a-4c, that can operate with inject and eject features when engaging a C-shaped chassis keeper opening 181. The Richco latch 179 has a pivoting lever pinned 183 to a PC card 185. A claw-shaped pawl 187 has its two fingers engaging the keeper 181 to provide a inject action when the latch is rotated into the PC card 185 and an eject action when the latch is rotated away from the PC card. The Richco device also has a second latch 187, FIGS. 5a-5c, similar to its first latch 179, except that this second latch 187 has a tongue-shaped pawl 189 for engaging the chassis keeper 181.

Southco Inc. has provided a PC card edge latch 191, FIGS. 6a-6e, that has an elongate hollow handle with a cutout to sit down on and extend over a PC card edge 193. This Southco latch 191 is pinned to the PC card with a rivet 195, thereby enabling the rotation of the latch 191. The latch 191 has a pair of rounded foot extensions 197 at its keeper 199 engaging end. The keeper 199 is a single curved spring, or a double curved spring 1101. When a single curved spring keeper 199 is used, it is mounted parallel to the side edge of the card 193. A double curved spring 1101 is mounted transverse to the side edge of a card 193 and can be engaged by adjoining latches 191 or adjoining PC cards.

The present invention provides an improvement to these commercially available PC board and PC card latches. The first embodiment of the present invention is shown in a perspective view of as the lever-style latch assembly 1103 in FIG. 7a. FIGS. 7b-7d show top, bottom, end, and side views of the assembly 1103, respectively. This inject-eject lever latch assembly 1103 has a lever handle component 1105, and a catch component 1107, carried on the lever 1105 and operable in relation thereto. A first compression spring 1109 is carried on the bottom face of the lever 11 05 and biases the catch 1107 away from the lever 1105. The catch 1107 is pivotally mounted to operate on the lever 1105, as described below.

The lever 1105 includes a pair of downwardly extending, juxtaposed, rounded journal plates 1111, each of which have a pivot hole 1113, which mates with a respective end of a pivot pin 1115, shown in FIG. 10, and permits the pivoting of the plates 1111 and thereby the lever 1105, with respect to a PC board 1117, shown in FIG. 10, to which the lever assembly 1103 is mounted for rotation, shown in FIGS. 10-12.

One of the pivot plates 1111 has a spring 1109 mounting platform 1119 extending outwardly, horizontally therefrom. The compression spring 1109 is mounted in a socket 1121 cup, in this spring mounting platform 1119, FIG. 8b. The opposite end of the spring 1109 presses against the adjacent bottom face of the catch 1107.

A second compression spring 1123 is attached to a receiving hole 1125 in the bottom of the lever 1105 and operates against the outside upward edge of the PC board 1117 to bias the lever 1105 away from the board/ card 1117 edge, as shown in FIG. 10.

The lever 1105 is shown in a perspective view in FIG. 8a. Top, bottom, end and side views of the lever 1105 are shown in FIGS. 8b-8e, respectively. This lever 1105 has a handle portion 1127, a catch 1107 operating portion 1129 and a projecting tongue 1131 which projects from the end of the lever 1105 opposite the handle 1127. This projecting tongue member 1131 acts as the pawl for engaging the C-shaped chassis/housing mounted flange keeper 1133, shown in FIGS. 10-12.

The handle 1127 has a low profile, flat shape with slightly recessed finger edge depressions 1135, FIGS. 8a, 8c, 8e. Extending in the plane of the handle 1127, and contiguous therewith, is the catch operating portion 1129 that is slightly narrower than the handle 1127. A pair of catch rotation sockets 1137 are positioned, one each, in each sidewall of the catch operating portion 1129 of the lever at a location spaced away from the projecting tongue 1131. A central rectangular opening 1139, extends along the longitudinal axis of the catch operating portion 1129. This opening 1139 allows for a clearance of the corner of the PC board 1117, curing the rotational operation of the lever assembly, FIGS. 10-12.

The tongue 1131 is slightly raised at an upward angle in respect to the plane of the handle 1127. This tongue 1131 has a rounded outer end. The outside wall of the spring platform 1119 is likewise rounded. The transition structure of the handle portion 1127 to the catch operating portion 1129 includes a pair of sidewall projecting stop abutments 1141, one on each sidewall of the catch operating portion 1129, so as to extend a short distance onto each journal plate 1111 face. These stop abutments 1141 operate to limit the upward rotation of the catch 1107. The catch operating portion 1129 transitions into the handle portion 1127 with a concave curved vertical rising face 1143. This concave face 1143 mates a curved convex face 1145, of the catch 1107, FIG. 9a.

The catch 1107 is shown in a perspective view in FIG. 9a, and in top, bottom, end and side views, respectively, FIGS. 9b-9e. The general shape of the catch is an H-shaped plate with two long side legs 1147 and two shorter side legs 1149. Carried on the inward facing sides of the longer legs 1147 is a pair of inward facing pivot journal-like members 1151. These journal-like members 1151 act as pivot shafts (stub shafts) for the catch 1107 and are received by the catch rotation sockets 1137 in the lever 1105 sidewall. These pivot stub shafts 1151 are each cylindrically shaped or round, with about a 45 degree flat on the bottom or downward facing portion of the outer wall. This makes for a half circle end profile which permits for ease of assembly.

Each long leg 1147 terminates its outer end with an abutment finger or projection 1153 that extends contiguous with the top surface of the handle member 1127 and is less than half the thickness of the handle 1127. These abutment projections 1153 are of a size and shape to mate with the abutment stops 1141 in the lever.

The short legs 1149 of the catch 1107 form a pair of parallel extending feet 1149, having rounded ends and a slight upwardly raised extension to match that of the lever tongue 1131. The catch 1107 legs are joined by a platform member 1155 which has the convex curved back face 1145 previously discussed. The top face of the platform 1155 is even with the top face of the side legs 1147. A spring receiving cup 1157 is formed under the platform 1155 as an inward extension of the respective leg 1147. This cup 1157 has its open face downward to receive the spring 1109. This cup 1157 extends the sidewall carrying the spring platform 1119. The top end of the first spring 1109 seats in this receiving cup 1157.

FIG. 10 shows the latch assembly 1103, with the handle 1127 partially rotated outward (upward) against its second spring 1123. The catch 1107 is carried at the same angle with its spring 1109 and is shown with the tongue 1131 at the end of the lever projecting into the box shape of the C-shaped chassis/housing flange keeper 1133. The keeper 1133 is mounted parallel to the side edge of the PC board 1117, with the free flange extension 1159 at the top.

When the lever assembly 1103 is rotated to the fully closed position, FIG. 11, the tongue 1131 abuts the bottom face of the free flange extension 1159 and fully injects the PC board into the chassis. The catch 1107 is depressed, to operate similar to a release button for releasing the second spring 1123 in order to pop-up the lever handle 1127, FIG. 12. This action then carries the entire assembly to rotate with it. Pulling on the handle 1127 causes the tongue 1131 to press against the bottom wall 1161 of the box opening, thereby creating an ejection pressure and movement. Thereafter, the handle 1127 can be rotated fully vertically, FIG. 13, to provide a clearance needed to remove the PC board 1117 from the chassis. This provides space for clearing the keeper 1133.

Upon reinsertion, FIG. 14, the lever assembly can slide past the keeper 1133. The catch is released, FIG. 15, by manually pressing it downwardly 1163 so that its projecting feet 1149 move below the (top) free flange extension 1159 of the keeper 1133. A small clearance for this movement is created because the catch 1107 is pivotally mounted on the lever 1105 and the position of the pivot point 1137 is adjusted for a limited movement.

Once the lever assembly 1103 is biased open, sufficient space above the top of the PC board (or card) 1117 exists for the handle 1127 end of the assembly 1103 to be grasped, by hand, FIG. 16. Further rotation and removal is as discussed above.

A close-up partial detail of FIG. 16 is shown in a top view in FIG. 17 and in a partial sectional view in FIG. 18. FIG. 19 shows a partial top view of the closed, lockout position of FIG. 11, with FIG. 20 showing a sectional side view. The each foot 1149 of the catch 1107 jambs against the squared-off end 1165 of the free flange extension 1159 of the keeper 133. This provides a positive lockout of the latch assembly 1103. By lockout is meant that the assembly 1103 cannot rotate, and the tongue 1131 remains abutting the bottom face of the free flange extension, thereby locking the PC board into the chassis/ housing. Unless the catch 1107 is depressed, this lockout remains.

Depressing the catch 1107, FIGS. 21 and 22, causes the spring 1109 to compress and the catch 1107 to rotate slightly so that its projecting feet 1149 (shown in dashed lines) are below the flange 1159 of the keeper 1133, with the tongue 1131, which thereby releases the biasing spring 1123 to cause the lever assembly 1103 to rotate to a position shown in FIG. 10.

FIGS. 23-29 each show a side view of a second embodiment of the invention. A PC board (card) 221 has a latch assembly 223 pivotally-mounted on an outer (upper) edge at a corner adjacent a chassis mounted keeper 225. This keeper 225 is also shown in relation to a loosened PC board 221, to an inserted and withdrawn PC board 221, and to an injected and ejected PC board 221. In FIG. 23 the latch assembly 223 is in the fully upright (outward extending) position. There is a space 227 between the PC board 221 and the keeper 225 for the latch 223 to pass by the keeper 225, FIG. 23, as the PC board 221 is inserted into the chassis.

The keeper 225 is C-channel shaped, with its base web 229 attached to the housing chassis (not shown) and its top flange 231 and bottom flange 233 each extending in parallel and being normal (orthogonal) towards the board 221.

The latch assembly 223 includes a lever having a finger grip handle 235 at one end, and a pawl 237 at the other end. The pawl 237 is a blade-shaped tongue extending in the plane of the handle 235 with a slight upward curve. Positioned over the body of the handle 235, and to slide thereon, is a bridge shaped catch 239. The handle 235 body rotates or pivots on the PC board 221 on a pivot pin 241. The catch 239 includes an least one elongate slot 242 which also is guided by the projections of the handle pivot pin 241 to slide on the lever towards the handle 235 or towards the tongue 237. These structures will be discussed in further detail below.

Once the PC board 221 is sufficiently inserted, FIG. 24, a shoulder on the catch 239 abuts the top flange 231 of the keeper 225. This causes the latch assembly 223 to rotate, FIG. 25, towards the PC board 221 outer edge on which it is mounted. This operation caused the tongue 237 to enter the open-sided boxed structure of the C-channel keeper 225. The catch 239 has at least one projecting foot 243, and is shown in FIGS. 34a-34d with two projecting feet 243, which abut the bottom flange 233 of the keeper 225. This causes the catch 239 to slide towards the handle 235 and thereby retract. The latch 223 is then able to fully rotate to the down position FIG. 26.

As the latch assembly 223 approaches the fully closed position, the tongue 237 contacts the inside face of the top flange 231 of the keeper 225. This forces an injection of the PC board 221 into the chassis. As this occurs, and after the catch projecting feet 243 clear the bottom flange 233 of the keeper 225, the catch 239 slides back into position fully extending with the position of the tongue 237, FIG. 26. In this position, the projecting feet 243 of the catch 239 are in contact with the inside face of the bottom flange 233 of the keeper 225. This thusly becomes the secured position for the PC board 221 and the lockout position for the latch 223. The latch 223 cannot accidentally move or begin to open. Therefore, the PC board 221 cannot accidentally shake loose from its chassis connection.

The handle 235 is spring biased to a rotated up position, FIG. 28. The catch 239 is spring biased to the lockout position, i.e., the locked position, FIG. 26. These biasing springs will each be further discussed below.

The latch assembly 223 is released to rotate when the catch 239 is manually slid back to a retracted position so that the projecting feet 243 clear the bottom flange 233, FIG. 27. When this occurs, and while the operator fingers are still on the retracting catch 239, the latch assembly 223 rotates to the released position, FIG. 28 under the force of the handle 235 biasing spring 245 shown in FIGS. 33 and 34e. The tongue 237 now rests against the inside face of the bottom flange 233 of the keeper 225. When the handle 235 is gripped and rotated outwardly manually, the PC board 221 is ejected from the chassis, FIG. 29. Once the handle is fully rotated to the upright position (outward facing), FIG. 23, the PC board 221 may be pulled from or inserted into the chassis.

FIG. 30 shows an enlarged perspective of the PC board 221 with latch assembly 223 mounted thereon and engaging the keeper 225 in the closed and locked-out position. FIG. 32 shows an enlarged top view of FIG. 30 and FIG. 31 shows an enlarged side view. Referring to FIG. 31, the lockout position for the latch assembly 223 with the keeper 225, it is easily recognized that the components being brought into contact thereby creates a force exerted by the tongue 237 and the projecting feet 243 of the catch 239 on the inside faces of the top and bottom flanges 231, 233, respectively. The board 221 is thereby locked into position and the latch assembly 223 is locked out from moving accidentally.

The lever assembly handle 235 biasing spring 245 is shown in the enlarged partial cross sectional view in FIG. 33, taken as shown in FIG. 32. This first spring 245 is a coil-type compression spring which operates against the adjacent edge 247 of the PC board 221 and is held in a receiving socket 249 in the bottom face of the body of the handle 235.

Also shown in this partial cross sectional view, FIG. 33, is the catch biasing spring 251 and slide catch 239 (not shown). This second biasing spring 251 is a coil-type compression spring which operates against a shoulder 253 on the body of the handle 235 and a shoulder on the slide catch 239 (not shown) which will be discussed below.

FIGS. 34a through 34e show various views of the latch assembly 223 with the catch 239 in the fully extended position so that the catch projecting feet 243 extend parallel to the tongue 237 and outwardly at the same approximate extension distance as the tongue 237. The catch 239 is bridge shaped which permits it to ride over the handle 235. The lever handle 235 is elongate and has the tongue 237 extending outwardly from one end thereof. The tongue 237 has a bladed edge 255. The tongue 237 is slightly curved upward so that its rounded tang edge will engage the inside face of the top flange 231 at a flat angle for enhanced pressure contact.

A pivot hole 240 for the handle 235 pivot pin 241 is seen in FIGS. 34c and 35c. The pivot pin 241, also shown in FIG. 31, extends through this (these) holes 240 and guides the sliding operation of the catch 239 when the pivot pin 241 extends through the elongate slot 242 in the slide catch 239. The position and structure of the catch biasing spring 251 also co-acts with the operation of the pin 241 and slot 242 to assure that the catch 239 will slide parallel to the longitudinal extension (axis) of the handle 235.

FIGS. 35a through 35e show various views of the one-piece lever's handle 235 and tongue 237. The handle 235 has a finger-gripping portion 257 and then divides into two parallel extending faces 259 in order to bridge over, i.e., extend over the outer edge of the PC board 221. The handle biasing spring 245 is shown in phantom in FIG. 35c, as well as is the receiving socket 249 which holds this spring 245. The location of the receiving socket 249 in the bottom face of the handle 235 at an inboard location is seen in FIGS. 35b and 35c. The location of this spring 245 and its strength affect the lifting force between the PC board 221 edge and the handle. As shown in FIGS. 35b and 35c it is in the body portion of the handle 235 nearer the tongue 237 side thereof. The tongue 237 is a contiguous structure with the handle 235, FIGS. 35a-35c.

A pair of juxtaposed projecting flanges 261, each with a rounded outer edge, project downwardly from the parallel faces 259. Each projecting flange 261 carries a hole 240, their being in alignment, which operates as the journal opening for the pivot pin 241. These handle-projecting flanges 261 act as the rotational journals for the pivoting lever handle 235. The distance 263, FIGS. 35d, 35e, between the parallel extending projecting flanges 261 permits the handle 235 to straddle a PC board 221.

A half-circle cross-sectional shaped cylindrical-type grove 264, FIGS. 35a, 35b, 35c, 35d extends along the outer face of one of the projecting flanges 261. This grove 264 terminates in the handle shoulder 253, FIG. 35c, previously discussed and provides a cavity in which the catch biasing spring 251 operates. The groove 264 extends parallel to the longitudinal axis of the handle 235 and helps control (guide) the longitudinal slide motion of the catch 239.

Catch 239 is shown in various views in FIGS. 36a through 36e. This slide catch 239 straddles the handle 235 and tongue 237 portions of the lever. The catch 239 is bridge-shaped with a top wall 265 and a first and second downward projecting, parallel extending, juxtaposed sidewalls 267, 269. Each sidewall 267, 269 carries the elongate slot 242 previously discussed. The walls 267, 269 each have oval-like rounded bottoms 271, extending below the respective elongate slot 242.

The projecting feet 243 extend in a plane parallel to the longitudinal axis of the elongate slots 242, which slots 242 intend extend parallel to the longitudinal axis of the handle 235 when the lever/latch 223 is assembled. Each of the projecting feet 243 terminates in a flat, squared-off-faced end 273, FIGS. 36a, 36b, 36c.

The first side wall 267 of the catch 239 has a half-circle cylindrical-type groove 275 on the inside face thereof. This groove 275 is a mating groove to the handle 235 groove 264. When the catch 239 is assembled over the handle 235 the two mating grooves 264, 275 form a cylindrical cavity for the catch biasing coil spring 251 to operate. The end of the catch groove 275 adjacent the projecting foot 243 terminates in a flat shoulder 277, FIG. 36c. This shoulder 277 is an abutment stop surface for the catch biasing spring 251 and co-operates with the handle abutment shoulder 253, on the handle 235, and in conjunction with the force of the spring 253 to push the catch 239 towards the blade edge 255 at the free end of the tongue 237. The elongate slot 242 defines the operating distance for sliding the catch 239 on the handle 235. Each end of this slot 242 operates as a stop for the retraction and extension of the catch 239.

The third embodiment of this invention incorporates a split ejector lever having two major components, a chassis-engaging pawl (tongue) and a handle (lever). This allows lever rotation by splitting the front end (the pawl) and the back end (the lever/handle) of the ejector. The split ejector results in a more simplified assembly, a more robust prying end of the ejector, and provides an ejector structure which does not depend upon the PC board edge or a chassis keeper flange for its catch function and popping open functions. In this third embodiment of the invention, the pawl is pivotally mounted to the handle, at one end thereof, for rotation in relation thereto; and a catch mechanism operates between the handle and the pawl and includes a catch arm implemented by a cantilevered flexible tab integral with the pawl and extending backward there from towards the handle. The end of this tab rotates with the rotation of the pawl. The handle has a flange or plate edge facing the tab with which the tab end engages as a pinch point to hold the pawl and handle in a fixed relationship in alignment with the same longitudinal axis. The pawl and handle also each have abutment shoulders that are engaged against one another to enhance the rigidity of the catch mechanism pinch point engagement.

FIG. 37 shows a partial perspective view of the split ejector latch assembly 321 mounted on a PC board 323 and engaging a C-shaped chassis keeper 325. The latch assembly 321 includes a split (two-piece) ejector having a lever handle 327 and a tongue/pawl 329. Integral with the tongue pawl 329 is a catch mechanism cantilever tab 331. This tab 331 has an operator button 333 on the top face.

FIG. 38 shows a side view of the latch assembly 331 with the handle 327 partially raised. (rotated off on the tope edge of the PC board 323. This the latch 321 is partially sprung open into an unlocked posture. A foot portion 335 of the pawl 329 engages the inner surfaces of the top 337 and bottom 339 horizontal flanges of the C-shaped channel 325. This channel member 325 operates as the chassis mounted keeper 325. The pawl 329 also includes a catch tab extending from the upward standing shoulder 341, the operation of which will be discussed below.

FIG. 39 shows the latch assembly 321 locked down on the outside edge of the PC board 323. In this position the handle portion 327 seats flush against the edge of the PC board 323 and the pawl foot 335 is in full engagement with the inner surfaces of the top flange 337 and bottom flange 339 of the C-channel 325.

A compression spring 343 is positioned to separate (rotate apart) the paw 329 from the C-channel 325 end of the handle 327 to which the pawl 329 is pivotally mounted onto a common pivot pin 347. FIG. 39 shows the latch assembly 321 in a locked state (locked-down). In this position, this spring 341 is fully compressed. The plane of the handle 327 grasping portion is also parallel to the extension of the pawl 329. Downwardly extending from the handle 327 includes a pair of side extension plates or journal bosses 345 which are used with the pivot pin 347 to permit the handle 327 to rotate on the PC board 323. FIG. 40 shows a top view of the locked-down assembly 321.

FIGS. 41a through 41f show a series of side views for the respective insertion, injection, lock-down, release and ejection, of a PC board 323, using the split ejector latch, latch assembly 321 of the third embodiment of the invention.

Insertion begins, FIG. 41a, with the handle 327 fully extended outwardly and the pawl 329 free to rotate to its counter clockwise (in the view) retracted position. The PC board 323 and latch assembly 321 are inserted downwardly into the chassis slot with a clearance 349 sufficient for the foot 335 of the pawl 325 to pass the flanges 337, 339 of the C-shaped keeper 325. With further insertion, the upstanding shoulder 341 of the pawl 329 engages the outside face of the top flange 337 on the keeper 325, which causes the pawl 329 to rotate back into the handle 327 and then the combined latch assembly to rotate back towards the PC board 323, FIGS. 41b and 41c. The biasing spring 343 is fully compressed by this action.

As the latch assembly 321 is rotated further towards the PC board 323, the foot 335 of the pawl 329 enters the open sided square boxed portion of the keeper and abuts the inner face of the top keeper flange 337. When the operator pushes the handle 327 fully down on the outside edge of the PC board 323, the pawl 325 foot 335 is fully within the C-shaped keeper 325 confines.

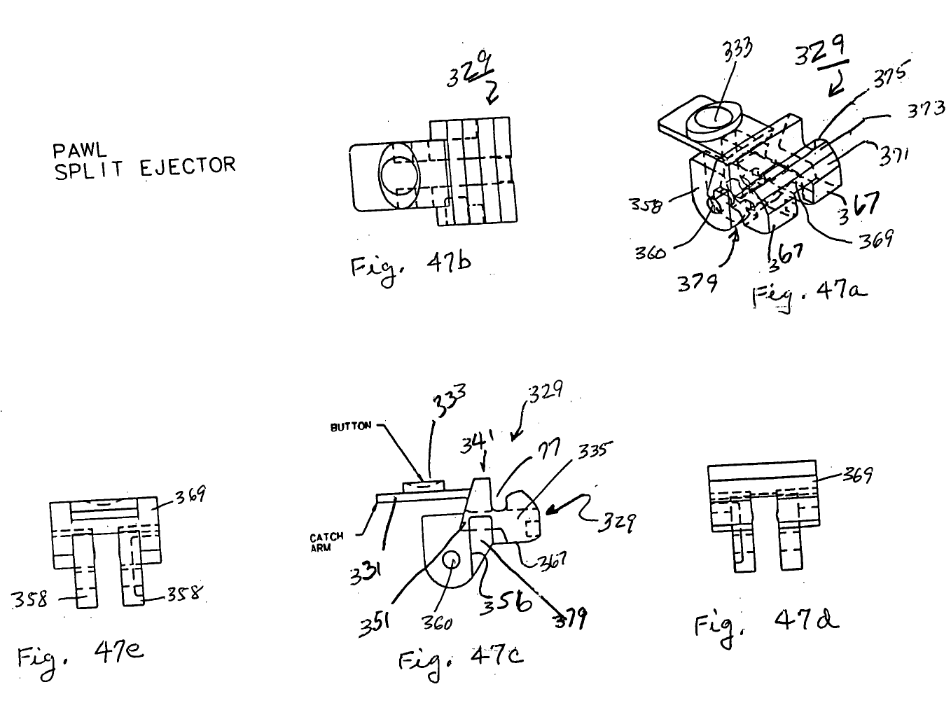

The pawl 329, in the region of its upstanding shoulder 341, also has a downwardly projecting abutment shoulder 351, FIGS. 41d and 47c, which seats against an upwardly projecting abutment shoulder 353 on the handle plates or journal boss 345, FIGS. 39, 41d and 45c. This seating aids in maintaining, i.e., locking, the alignment of the two ejector latch parts, the handle 327 and pawl 329.

Pressing the button 333 releases the two pieces and the handle 327 is free to rotate upwardly away from its previous position with the pawl 329 under the force of the spring 343. This rotation stops when the handle 327 end shoulder 354 meets the tapered face 355 of the pawl upstanding abutment shoulder 341, FIG. 41e.

Ejection occurs, FIG. 41f, when the operator swings the handle 327 further outwardly, i.e., clockwise in FIG. 41f, whereby the bottom of the pawl foot 335 engages the bottom flange 339 of the chassis keeper3 25, and the pawl upstanding shoulder 341 slides over the top of the top keeper flange 337.

FIG. 42 is a cross-sectional view of the locked down latch assembly 321 with the catch mechanism engaged. The catch mechanism, which includes the cantilever tab 331, has this tab 331 extending backwardly from the tapered face 355 of the upstanding pawl shoulder 341. The free end of the tab 331 abuts the face of a flange/plate surface 357 to form a pinch point which acts under a frictional fit as a catch force to hold the handle 327 in the alignment with the pawl 329 as shown in FIG. 42. The tab 333 is flexible. When the operator pushes down on the button 333 carried on the top face of the cantilevered tab3 31, it moves downward enough to clear the adjacent facing edge 357 (handle flange face 357) which then allows the spring 433 to rotate the handle 327 to the position shown in FIGS. 41e and 44.

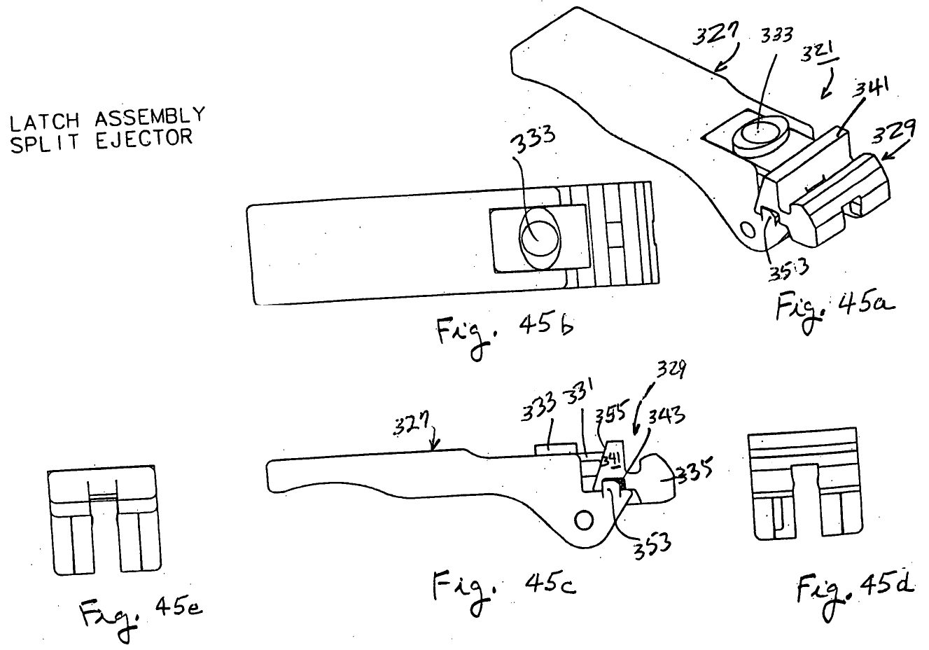

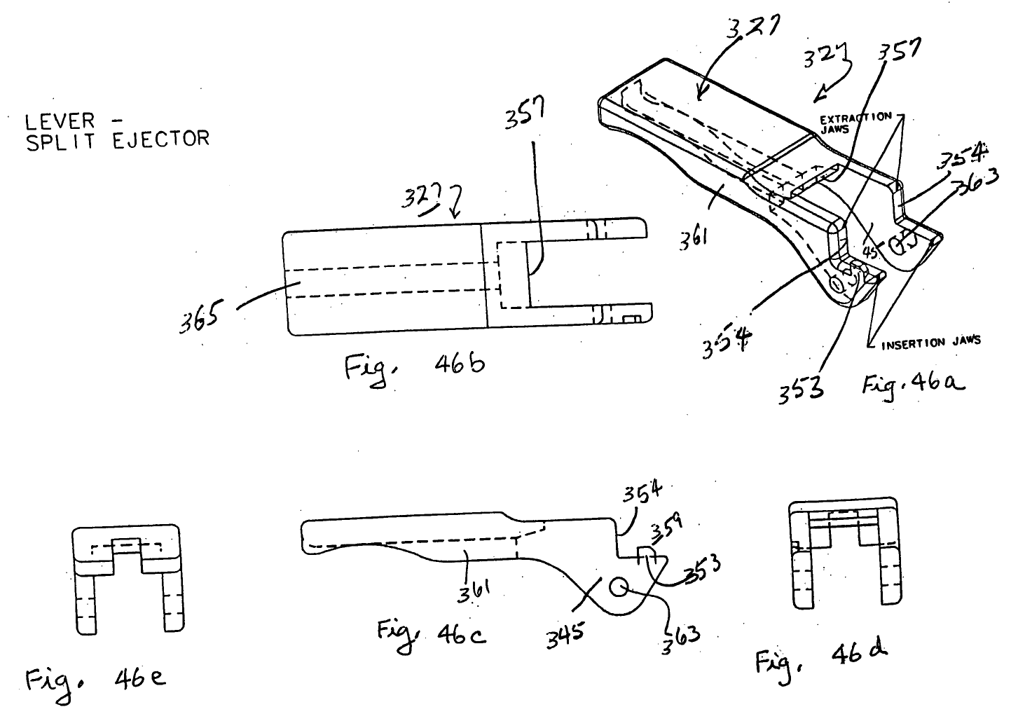

The two-piece, split ejector latch 321 is shown in a perspective view, FIG. 45a, in which the two principal pieces, the handle 327 and pawl 329 are seen. Other views of this split ejector lever assembly 321 are presented respectively as a top view, side view, right end (pawl end) view, and left end (handle grasping end) view in FIGS. 45b, 45c, 45d and 45e, respectively. In each of these views, FIGS. 45a-45e, the pawl 329 and the handle 327 are aligned in the locked position. The handle end upstanding shoulder 353 has a truncated outer corner 359, FIG. 46c, facing the pawl foot 335.

The handle 327 is shown, respectively, in perspective view, top view, side view, right end (pawl end) view and left end (grasping end) view, in FIGS. 46a, 46b, 46c, 46d, and 46e, respectively. The handle 327 includes a pair of downward extending outer sidewalls 361 which permit the handle 327 to seat down over the edge of a PC board. Each of these outer sidewalls 361 continues into a respective side extension plate, i.e., a journal boss 345. Each boss 345 has a hole 363 for the common pivot pin 347. The handle end shoulders 354 operate as part of the extraction jaws during the pulling- up to the handle 327, FIG. 41f, during the ejecting operation. These shoulders 354 seat against the tapered face 355 of the upstanding pawl shoulder 341. The grasping portion of the handle 327 includes a plate 365 bridging between the sidewalls 361.

The pawl 329 is shown, respectively, in perspective view, top view, side view, right end (foot end) view and left end (cantilever tab end) view in FIGS. 47a, 47b, 47c, 47d, and 47e, respectively. The pawl 329 foot 335 portion engages the C-channel 325 in a snug fit when inserted thereinto. The foot 325 has a pair of outwardly forward projecting longitudinal plates 367 which are bridged by an upper transverse plate 369. The keeper-engaging portion of this foot 335 is the transverse plate 369, which carries a series of a first and second tapered, i.e., truncation surfaces 371, 373 and a top surface 375.

The foot portion 335 is spaced from the upstanding shoulder portion 341 by a distance 377 sufficient for spacing allowance for the top flange 337 of the keeper 325, FIGS. 41c and 41f. The base of the upstanding shoulder 341 includes a cavity 379 creating the downward abutment shoulder 351 which seats against the upward abutment shoulder 353 on the handle 329 right journal boss 345.

Two parallel downward projecting plates 358, extend below the upstanding shoulder 341. Each pawl plate carries a pivot hole 360 aligned with the other for pivoting on the common pivot pin 347. The pivot plates 358 of the pawl 329 fit inside the pivot plates 345 of the handle 327. The pawl is free to pivot up to abutment with the handle end shoulders 354. When the free end of the cantilevered tab 331 is forced against the handle flange 357, the two pieces 327, 329 are held rigidly fixed to one another. Depressing the button flexes the tab and frees the friction fit between the end of the tab 331 and the flange 357, and the compressed spring 343 causes the pawl 329 to rotate, FIG. 38.

In the locked position, the upward abutment shoulder 353 on the handle acts as a position stop against the top of the cavity 379 in the pawl, FIGS. 39 and 47c. This upward abutment shoulder 353 also keeps the spring 343 within the cavity 379. One end of the spring seats against the respective one of the insertion jaws formed by the plates 345, and exerts a biasing force to separate by rotation, the handle plates 345 from the pawl 329. The location of the rearward edge 356 of the cavity 379 is determined by the position and size of the upward abutment shoulder 353.

Many changes can be made in the above-described invention without departing from the intent and scope thereof. It is therefore intended that the above description be read in the illustrative sense and not in the limiting sense. Substitutions and changes can be made while still being with the scope of the appended claims.

What is claimed is:

1. An inject-eject lever latch mountable to an outboard edge of a chassis mountable PC board for engaging a chassis keeper, comprising:
a lever shaped handle pivotally mountable to said PC board;
a pawl connected to said handle and movable therewith; and
means sensitive to said pawl position with respect to said chassis keeper for providing an interference catch state.

2. The lever latch of claim 1, wherein said chassis keeper comprises as pocket style keeper including top and bottom walls, and wherein said pawl is positioned to engage the inside of said keeper top wall when said latch is in the closed position.

3. The lever latch of claim 1, wherein said chassis keeper is a C-channel member having a top and bottom flanges, the top flange thereof terminating in a free end, and wherein said pawl is positioned to engage the inside of said C-channel top flange when said latch is in the closed position.

4. The lever latch of claim 3, wherein said position sensitive catch means includes a catch member pivotally mounted to said handle and having at least one protruding leg, said leg being positioned against said free end of said C-channel top flange when said catch means is in said interference state.

5. The lever latch of claim 4, wherein said lever shaped handle includes an elongate grasping portion and a pair of parallel extending, spaced apart journal plate members each extending outwardly from the end of said grasping portion and parallel to the longitudinal axis of said grasping portion, wherein each journal plate has a pivot hole in alignment with the other, wherein said pawl is a blade type member extending from and connected to both said journal plate members, and also including a spring positioned between said catch member and one of said journal plate members to bias said catch member pivotally away from said journal plate member.

6. The lever latch of claim 5, wherein the top face of said elongate grasping portion extend in a plane, wherein said pawl extends upwardly to said plane of said grasping portion top face, and wherein said catch member and said protruding leg thereof are pivotable to extend into the plane of said grasping portion top face when said protruding leg is positioned against said fee end of said C-channel top flange.

7. The lever latch of claim 3, wherein said position sensitive catch means includes a catch member slideably mounted to said handle and having at least on projecting foot, said foot being positioned against said C-channel bottom flange when said catch means is in said interference state.

8. The lever latch of claim 7, wherein said handle includes an elongate grasping portion, and a pair of juxtaposed flanges projecting from one end thereof, said flanges each having a pivot hole in alignment with the other, wherein said pawl extends from said same end of said handle grasping portion as said flanges, and is positioned transversely thereto, wherein said catch member is shaped to straddle said handle grasping portion with a top wall thereof and to straddle the outside of each of said flanges with a sidewall thereof, wherein at least one of said catch member sidewalls has said projecting foot extending therefrom.

9. The lever latch of claim 8, also including a pin end extending outwardly from each of said handle flanges, an elongate slot in each of said catch member sidewalls adjacent to said extending pin end, said pin end extending into a respective slot to guide said slidable movement of said catch to said handle, said catch member also including a first groove in one of said sidewalls thereof, and a second groove in one of said handle flanges, said first and second grooves facing one another to form an elongate encasement, and a spring positioned in said encasement to bias said catch member position with respect to said handle.

10. The lever latch of claim 3, wherein said pawl connection to said handle includes a common pivot pin on which both said handle and said pawl rotate, wherein said position sensitive catch means includes a cantilevered tab projecting from said pawl towards said handle, wherein said handle includes an interference shoulder, and wherein said cantilevered tab is positioned against said handle interference shoulder when said catch means is in said interference state.

11. The lever latch of claim 10, wherein said handle includes a grasping portion with a top face extending in a plane, and a pair of parallel extending journal plates, each having a pivot hole therein for said common pivot pin to extend there through, said journal plates extending transversely to said plane of said grasping portion top face, and wherein said interference shoulder is at the end of said grasping portion adjacent said journal plates and facing away from the plane of said grasping portion top face.

12. The lever latch of claim 11, wherein said pawl also includes a pair of sidewalls extending below said cantilevered tab, each said sidewall having a pivot hole for said common pivot pin, said pawl further including a upstanding shoulder supporting said cantilevered tab and a foot portion extending from said upstanding shoulder and said sidewalls on the opposite side thereof from said cantilevered tab.

13. The lever latch of claim 12, wherein said foot portion has a top surface spaced from said upstanding shoulder, and a pair of parallel extending downwardly projecting plates, wherein said foot portion is sized to fit between said top and bottom flanges of said C-channel.

14. The lever latch of claim 13 also including a spring positioned between said pawl and at least on of said handle journal plates biasing said pawl to a rotated out of alignment position.

15. An inject-eject lever latch for a PC board, for engaging a chassis keeper, comprising:
a lever shaped handle pivotally mountable to said PC board, said handle carrying an abutment shoulder adjacent the keeper facing end of the handle; and
a pawl for engaging said keeper said pawl being pivotally movable with respect to said handle and having a tab for engaging said handle abutment shoulder, whereof a friction fit occurs therebetween to hold said pawl and said lever in a predetermined fixed positional relationship when said pawl is at a predetermined pivoted position with respect to said handle.

16. The lever latch of claim 15, wherein when said handle and pawl are in said friction fit they are longitudinally in alignment with one another.

17. The lever latch of claim 16, wherein said friction fit is released by pressing said tab towards said handle.

18. The lever latch of claim 17, wherein said handle and said pawl are mounted for rotation on a common axis.

19. The lever latch of claim 18, wherein said handle includes a flat grasping portion extending in a plane, and a pair of parallel extending journal plates extending therefrom, said journal plates each having a pivot holes for mounting onto a pivot pin, said journal plates extension being transverse to the plane of extension of said grasping portion.

20. The lever latch of claim 19, wherein said handle tab abutment shoulder is adjacent to said journal plates and facing thereto.

21. The lever latch of claim 20, wherein said handle journal plates each have an insertion edge facing upward to the plane of said grasping portion, and an extraction edge facing outwardly from said grasping portion and orthogonal to said insertion facing edges.

22. The lever latch of claim 21, wherein said handle also includes an upward abutment shoulder on one of said journal plates rising up from a said insertion edge thereof.

23. The lever latch of claim 22, wherein said pawl includes a foot for engaging said keeper, and a pair of transverse facing parallel pivot plates, extending backwardly therefrom toward said handle grasping portion, said pawl pivot plates each having a pivot hole for mounting onto a pivot pin.

24. The lever latch of claim 23, wherein said handle and said pawl pivot pin is a common pivot pin, and wherein said pawl pivot plates extend inside of said handle journal plates.

25. The lever latch of claim 24, wherein said pawl also includes an upward standing tapered shoulder, said handle shoulder engaging tab being cantilevered towards said handle grasping portion shoulder from said upward standing tapered shoulder.

26. The lever latch of claim 25, wherein said pawl pivot plate adjacent said handle journal plate carrying said upward standing abutment shoulder has a elongate cavity therein, said cavity extending towards said plane of said handle grasping portion.

27. The lever latch of claim 26, also including a compression spring operating in said pawl pivot plate cavity and held in place by said handle journal plate upstanding shoulder.

28. The lever latch of claim 27, wherein said pawl foot is spaced from said upward standing tapered shoulder.

29. The lever latch of claim 28, wherein said pawl foot includes a transversely extending plate and a pair of outwardly extending and spaced apart projecting plates.

30. The lever latch of claim 29, wherein said handle extraction edges engage the tapered face of said pawl tapered upstanding shoulder on an extraction motion of said lever latch, and said handle insertion edges engage the bottom of said pawl on an insertion motion of said lever latch.
